(19) United States
(12) Patent Application Publication
(10) Pub. No.: US 2013/0083000 A1
(43) Pub. Date: Apr. 4, 2013

(54) PIXEL CIRCUIT, PIXEL CIRCUIT DRIVING METHOD, DISPLAY APPARATUS, AND ELECTRONIC DEVICE

(71) Applicants: Naobumi Toyomura, Kanagawa (JP); Katsuhide Uchino, Kanagawa (JP)

(72) Inventors: Naobumi Toyomura, Kanagawa (JP); Katsuhide Uchino, Kanagawa (JP)

(73) Assignee: SONY CORPORATION, Tokyo (JP)

(21) Appl. No.: 13/611,234

(22) Filed: Sep. 12, 2012

(30) Foreign Application Priority Data
Sep. 30, 2011 (JP) 2011-216114

(51) Int. Cl. G06F 3/038

(52) U.S. Cl. 345/212

(57) ABSTRACT

Disclosed herein is a pixel circuit including: a light-emitting device; a constant current drive circuit configured to include a first transistor as a constant current source for supplying a predetermined current to the light-emitting device; a second transistor configured to open/close electrical connection between the first transistor and the light-emitting device; and a switching circuit configured to switch between an on state and an off state of the second transistor by controlling a gate voltage of the second transistor.

### BACKGROUND

The present technology relates to a pixel circuit, a pixel circuit driving method, a display apparatus, and an electronic device and, more particularly, to a pixel circuit, a pixel circuit driving method, a display apparatus, and an electronic device that are configured to drive light-emitted devices in a constant current PWM (Pulse Width Modulation) drive manner.

With displays based on light-emitting devices of self-light emission type, such as an organic electro luminescence device (hereafter referred to simply as organic EL device) or an LED (Light Emitting Diode) device, a drive circuit providing the back plane must be selected in accordance with the characteristics of the light-emitting device used. For example, use of a current-driven drive circuit if the light emission wavelength of the light-emitting device has current density dependability causes for chromaticity to change depending on gray level.

In order to solve the above-mentioned problem, constant current PWM (Pulse Width Modulation) drive is effective in which a constant current is supplied to a light-emitting device regardless of gray level and a current supply time is controlled to control gray level by controlling the light emission period of the light-emitting device (for example, refer to Japanese Patent Laid-open No. 2006-215274, hereinafter referred to as Patent Document 1).

### SUMMARY

However, with a constant current PWM drive circuit disclosed in Patent Document 1, a current is not instantaneously cut off in stopping the supply of the current to a light-emitting device but gradually lowers over a certain period of time. As a result, there exists a period of time in which the current supplied to the light-emitting device is not constant, thereby degrading image quality.

Therefore, the present technology addresses the above-identified and other problems associated with related-art methods and apparatuses and solves the addressed problems by providing a pixel circuit, a pixel circuit driving method, a display apparatus, and an electronic device that are configured to enhance the image quality of display apparatuses driving light-emitting devices in a constant current PWM drive manner.

In carrying out the technology and according to a first embodiment thereof, there is provided a pixel circuit. This pixel circuit has a light-emitting device; a constant current drive circuit configured to include a first transistor as a constant current source for supplying a predetermined current to the light-emitting device; a second transistor configured to open/close electrical connection between the first transistor and the light-emitting device; and a switching circuit configured to switch between an on state and an off state of the second transistor by controlling a gate voltage of the second transistor.

The above-mentioned switching circuit may include a third transistor for opening/closing electrical connection between a gate of the second transistor and a predetermined potential and connect the gate of the second transistor to the potential via the third transistor, thereby turning off the second transistor.

The above-mentioned pixel circuit may further have a signal input circuit configured to enter a ramp signal that increases or decreases from an initial voltage corresponding to a luminance of a pixel in predetermined slope into the gate of the third transistor.

The above-mentioned signal input circuit may set the initial voltage with reference to a threshold voltage of the third transistor.

The above-mentioned signal input circuit may set the initial voltage by applying a voltage corresponding to the luminance of the pixel to the gate of the third transistor via a capacitor with the gate voltage of the third transistor set to a threshold voltage.

The above-mentioned constant current drive circuit may set a gate voltage of the first transistor to a first value obtained by adding a predetermined bias voltage to a threshold voltage of the first transistor, thereby supplying a current to the light-emitting device.

The above-mentioned constant current drive circuit may set the gate voltage of the first transistor to a second value obtained by further subtracting a voltage corresponding to a mobility of the first transistor from the first value and supply a current to the light-emitting device.

In carrying out the technology and according to a second embodiment thereof, there is provided a pixel circuit driving method. This method includes supplying a predetermined current to a light-emitting device from a constant current drive circuit including a first transistor as a constant current source, thereby causing the light-emitting device to emit light; and controlling a gate voltage of a second transistor for opening/closing electrical connection between the first transistor and the light-emitting device to turn off the second transistor, thereby stopping light emission of the light-emitting device.

In carrying out the technology and according to a third embodiment thereof, there is provided a display apparatus. This display apparatus has a pixel array in which pixel circuits are arranged in a matrix and a drive control block configured to control driving of the pixel circuits. Each of the pixel circuits includes a light-emitting device, a constant current drive circuit configured to include a first transistor as a constant current source for supplying a predetermined current to the light-emitting device, a second transistor configured to open/close electrical connection between the first transistor and the light-emitting device, and a switching circuit configured to switch between an on state and an off state of the second transistor by controlling a gate voltage of the second transistor.

In carrying out the technology and according to a fourth embodiment thereof, there is provided an electronic device. This electronic device has a pixel array in which pixel circuits are arranged in a matrix and a drive control block configured to control driving of the pixel circuits. Each of the pixel circuits includes a light-emitting device, a constant current drive circuit configured to include a first transistor as a constant current source for supplying a predetermined current to the light-emitting device, a second transistor configured to open/close electrical connection between the first transistor and the light-emitting device, and a switching circuit configured to switch between an on state and an off state of the second transistor by controlling a gate voltage of the second transistor.

In the first embodiment of the technology, the gate voltage of the second transistor for opening/closing the electrical connection between the first transistor and the light-emitting device is controlled to switch between an on state and an off state of the second transistor, thereby controlling the supply of a current to the light-emitting device.

In the second embodiment of the technology, a predetermined current is supplied from the constant current drive circuit including the first transistor that is a constant current source, thereby causing the light-emitting device to emit light; the gate voltage of the second transistor for opening/closing the electrical connection between the first transistor and the light-emitting device is controlled to turn off the second transistor, thereby stopping the light emission of the light-emitting device.

In the third or fourth embodiment of the technology, the gate voltage of the second transistor for opening/closing the electrical connection between the first transistor and the light-emitting device is controlled to switch between the on-state and off state of the second transistor, thereby controlling the supply of a current to the light-emitting device.

According to the first through fourth embodiments of the technology, the image quality of a display apparatus for driving light-emitting devices is enhanced on the basis of constant current PWM drive.

### BRIEF DESCRIPTION OF THE DRAWINGS

FIG. 1 is a circuit diagram illustrating an exemplary configuration of a related-art constant current PWM drive circuit;

FIG. 2 is a timing chart indicative of a method of driving the related-art constant current PWM drive circuit;

FIG. 3 is a block diagram illustrating an exemplary configuration of a display apparatus practiced as one embodiment of the technology;

FIG. 4 is a circuit diagram illustrating an exemplary basic configuration of a pixel circuit;

FIG. 5 is a circuit diagram illustrating a pixel circuit practiced as a first embodiment of the technology;

FIG. 6 is a timing chart indicative of a method of driving the pixel circuit practiced as the first embodiment of the technology;

FIG. 7 is a circuit diagram illustrating a pixel circuit practiced as a second embodiment of the technology;

FIG. 8 is a timing chart indicative of a method driving the pixel circuit practiced as the second embodiment of the technology;

FIG. 9 is a circuit diagram illustrating a pixel circuit practiced as a third embodiment of the technology;

FIG. 10 is a timing chart indicative of a method driving the pixel circuit practiced as the third embodiment of the technology;

FIG. 11 is a circuit diagram illustrating a first variation to the pixel circuit practiced as the third embodiment of the technology;

FIG. 12 is a timing chart indicative of a method driving the first variation to the pixel circuit practiced as the third embodiment of the technology;

FIG. 13 is a circuit diagram illustrating a second variation to the pixel circuit practiced as the third embodiment of the technology;

FIG. 14 is a timing chart indicative of a method driving the second variation to the pixel circuit practiced as the third embodiment of the technology;

FIG. 15 is a circuit diagram illustrating a pixel circuit practiced as a fourth embodiment of the technology;

FIG. 16 is a timing chart indicative of a method of driving the pixel circuit practiced as the fourth embodiment of the technology;

FIG. 17 is a circuit diagram illustrating a first variation to the pixel circuit practiced as the fourth embodiment of the technology;

FIG. 18 is a timing chart indicative of a method of driving the first variation to the pixel circuit practiced as the fourth embodiment of the technology;

FIG. 19 is a circuit diagram illustrating a second variation to the pixel circuit practiced as the fourth embodiment of the technology;

FIG. 20 is a timing chart indicative of a method of driving the second variation to the pixel circuit practiced as the fourth embodiment of the technology;

FIG. 21 is a circuit diagram illustrating a pixel circuit practiced as a fifth embodiment of the technology;

FIG. 22 is a timing chart indicative of a method of driving the pixel circuit practiced as the fifth embodiment of the technology;

FIG. 23 is a circuit diagram illustrating a pixel circuit practiced as a sixth embodiment of the technology;

FIG. 24 is a timing chart indicative of a method of driving the pixel circuit practiced as the sixth embodiment of the technology;

FIG. 25 is a schematic diagram illustrating an exemplary functional configuration of an electronic device;

FIG. 26 is a perspective view of an exemplary commercial product of an electronic device;

FIGS. 27A and 27B are perspective views of an exemplary commercial product of an electronic device;

FIG. 28 is a perspective view of an exemplary commercial product of an electronic device;

FIGS. 29A and 29B are top views of an exemplary commercial product of an electronic device; and

FIG. 30 is a perspective view of an exemplary commercial product of an electronic device.

### DETAILED DESCRIPTION OF THE PREFERRED EMBODIMENTS

This technology will be described in further detail by way of embodiments thereof with reference to the accompanying drawings. It should be noted that the description will be done in the following order:

1. related-art constant current PWM drive circuit;

2. embodiment of display apparatus;

3. exemplary basic configuration of pixel circuit;

4. first embodiment of the pixel circuit;

5. second embodiment of the pixel circuit (example of correcting switching transistor threshold voltage);

6. third embodiment of the pixel circuit (example of correcting drive transistor threshold voltage);

7. first variation to the pixel circuit practiced as the third embodiment;

8. second variation to the pixel circuit practiced as the third embodiment;

9. pixel circuit practiced as the fourth embodiment (example of correcting drive transistor and switch transistor threshold voltage);

10. first variation to the pixel circuit practiced as the fourth embodiment;

11. second variation to the pixel circuit practiced as the fourth embodiment;

12. fifth embodiment of the pixel circuit (example of correcting drive transistor threshold voltage and mobility);

13. sixth embodiment of the pixel circuit (example of correcting drive transistor threshold voltage and mobility and switching transistor threshold voltage);

14. examples of products (electronic devices) to which the technology disclosed herein is applied; and

15. variations.

### <1. Related-Art Constant Current PWM Drive Circuit>

### [Circuit Configuration]

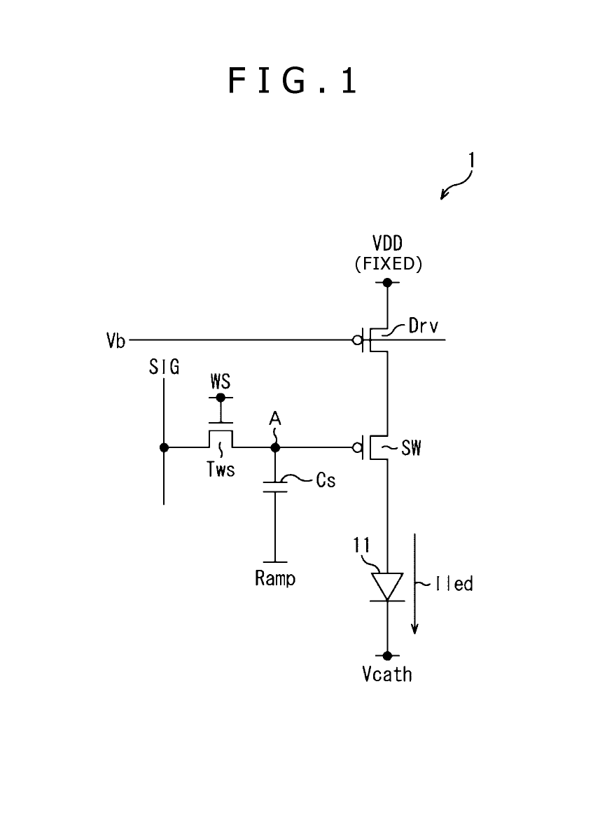

Now, referring to FIG. 1, there is shown an exemplary configuration of a related-art constant current PWM drive circuit.

A constant current PWM drive circuit 1 has a drive transistor Drv for current source, a switching transistor SW for switching, a write transistor Tws for writing a signal, and a capacitor Cs. The drive transistor Drv and the switching transistor SW are each configured by a P-channel type transistor and the write transistor Tws is configured by an N-channel type transistor.

The drain of the drive transistor Drv is connected to power supply VDD to be applied with a fixed voltage VDD. The gate of the drive transistor Drv is connected to bias power supply to be applied with a bias voltage Vb. The source of the drive transistor Drv is connected to the drain of the switching transistor SW. The drive transistor Drv operates as a constant current source by fixing the bias voltage Vb to a predetermined value.

The gate of the switching transistor SW is connected to point A and the source is connected to the anode of a light-emitting device 11.

To the drain of the write transistor Tws, video signal SIG is applied, gate signal WS is applied to the gate, and the source is connected to point A.

One end of the capacitor Cs is connected to point A and the other end is applied with ramp signal Ramp.

To the cathode of the light-emitting device 11, a voltage Vcath is applied.

### [Driving Method]

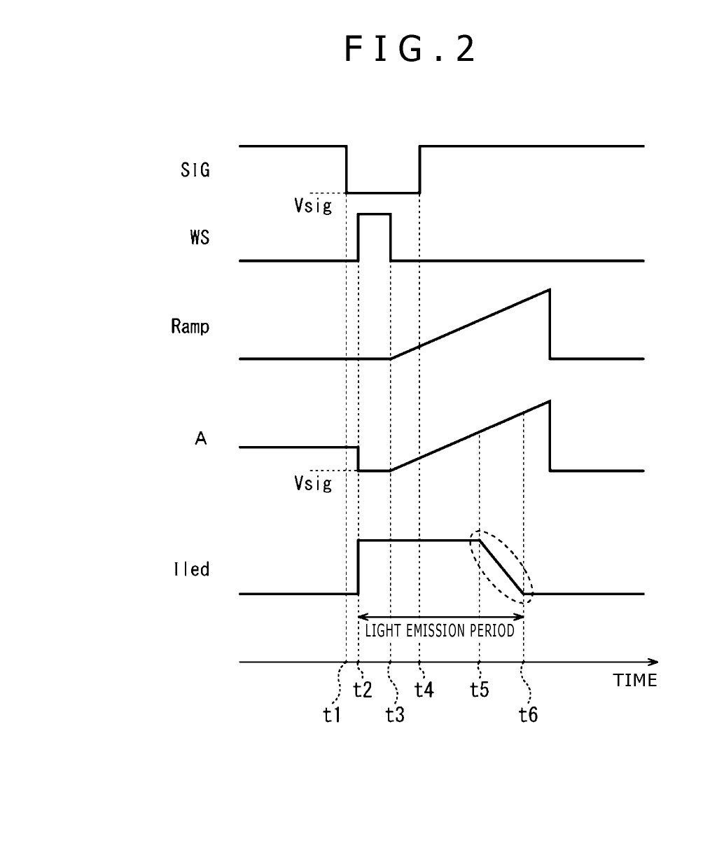

The following describes a method of driving the constant current PWM drive circuit 1 with reference to the timing chart shown in FIG. 2.

At time t1, a video signal SIG is set to signal voltage Vsig corresponding to the luminance of a pixel to be driven by the constant current PWM drive circuit 1.

At time t2, gate signal WS goes High to turn on the write transistor Tws. Consequently, the potential at point A lowers to signal voltage Vsig. Then, an absolute value of gate voltage Vgs between the gate and source of the switching transistor SW exceeds threshold voltage Vth, turning on the switching transistor SW. Consequently, a current Iled begins to flow to the light-emitting device 11, upon which the light emission of the light-emitting device 11 starts.

At time t3, gate signal WS goes Low, the write transistor Tws is turned off, and point A goes high impedance, upon which the input of ramp signal Ramp starts. Ramp signal Ramp is a signal with voltage increasing with a predetermined slope. As the voltage of ramp signal Ramp goes up, the potential at point A goes up through the capacitor Cs.

At time t4, video signal SIG is set to reset level.

Next, as the voltage of ramp signal Ramp goes up, the potential at point A goes up. When the absolute value of gate voltage Vgs of the switching transistor SW reaches threshold voltage Vth at time t6, the switching transistor SW is turned off. Consequently, the supply of current Iled to the light-emitting device 11 is stopped, thereby stopping the light emission of the light-emitting device 11.

However, when a state of the constant current PWM drive circuit 1 at the stopping of light emission is closely observed, the operation region of the switching transistor SW transitions from a linear region to a saturated region at time t5 immediately before the potential at point A goes up to cut off the switching transistor SW. Hence, between time t5 and time t6, the switching transistor SW behaves as a current source.

Consequently, as indicated by the area enclosed by dashed circle shown in FIG. 2, as the potential (gate voltage Vgs of the switching transistor SW) at point A goes up, current Iled gradually lowers over time, eventually reaching 0 at time t6. Thus, with the constant current PWM drive circuit 1, there exists a period in which current Iled is not cut off instantaneously and does not become constant, thereby preventing the realization of an ideal constant current PWM drive operation. This problem causes the degradation of image quality.

In order to solve the above-mentioned problem, the technology disclosed herein realizes an ideal constant current PWM drive operation by instantaneously cutting off the current to a light-emitting device.

### <2. Embodiment of Display Apparatus>

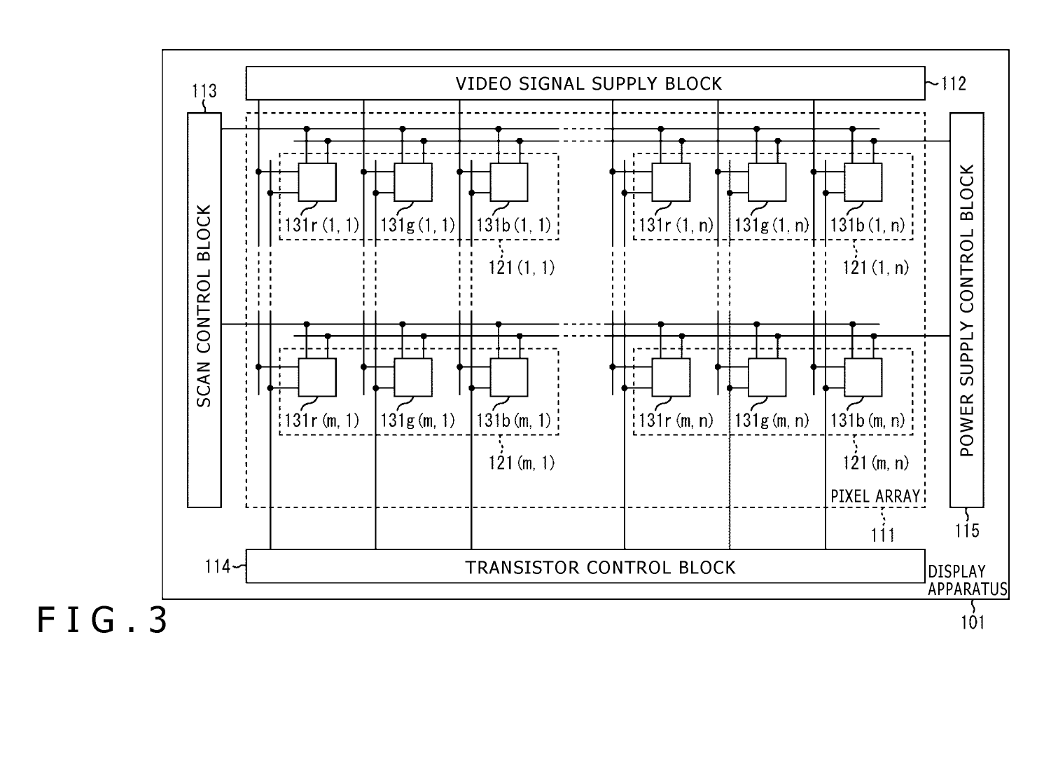

Referring to FIG. 3, there is shown a block diagram illustrating a display apparatus to which an embodiment of the technology disclosed herein is applied.

A display apparatus 101 shown in FIG. 3 has a pixel array 111, a video signal supply block 112, a scan control block 113, a transistor control block 114, and a power supply control block 115.

On the pixel array 111, pixel units 121 (1, 1) through 121 (m, n) are arranged in a matrix of m rows×n columns.

The pixel unit 121 (i, j) (1≦i≦m, 1≦j≦n) has a pixel circuit 131r (i, j) for R (Red), a pixel circuit 131g (i, j) for G (Green), and a pixel circuit 131b (i, j) for B (Blue).

It should be noted that if the pixel units 121 (1, 1) through 121 (m, n) need not be individually distinguished, the pixel units are generically referred to simply as the pixel unit 121. If the pixel circuits 131r (1, 1) through 131b (m, n) need not be individually distinguished, the pixel circuits are generically referred to simply as the pixel circuit 131.

The video signal supply block 112 supplies video signal SIG of signal voltage Vsig corresponding to the luminance of each pixel to the pixel circuit 131 via a video signal line.

The scan control block 113 supplies a predetermined control signal to the pixel circuit 131 via a scan line to control scan of each row of the pixel array 111.

The transistor control block 114 supplies a predetermined control signal to each pixel circuit 131 via a control line to control an operation of a transistor incorporated in each pixel circuit 131.

The power supply control block 115 supplies an electric power necessary for each pixel circuit 131 to operate and a voltage providing the reference to the operation.

Drive of each pixel circuit 131 of the pixel array 111 is controlled by the video signal supply block 112, the scan control block 113, the transistor control block 114, and the power supply control block 115.

It should be noted that the number of video signal lines, the number of scan lines, the number of control lines, and the number of power supply lines for each pixel circuit 131 are not necessarily one; two or more lines may be arranged as required.

### <3. Exemplary Basic Configuration of Pixel Circuit>

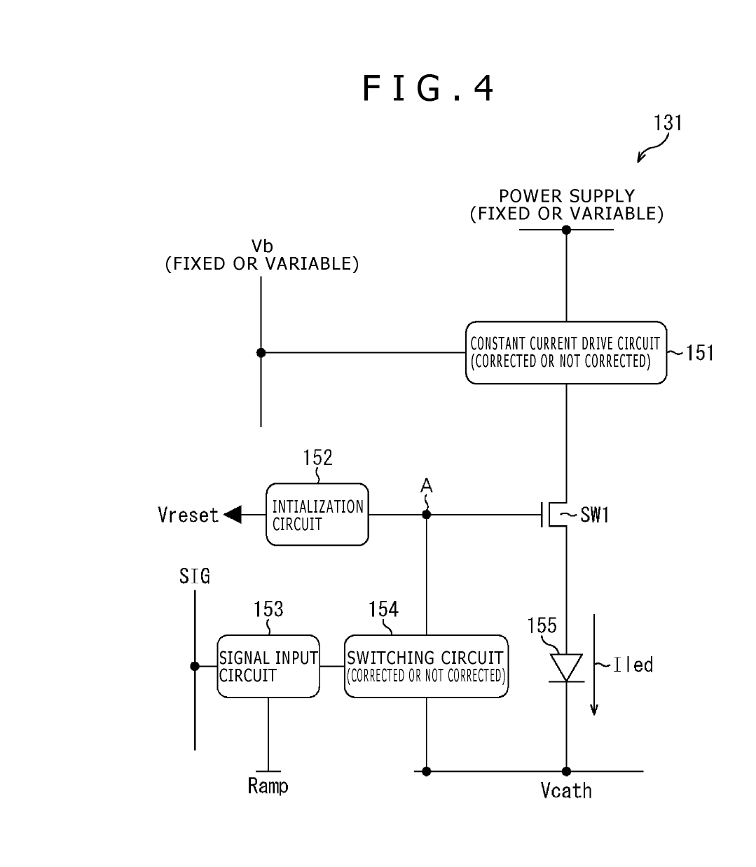

Referring to FIG. 4, there is shown an exemplary basic configuration of the pixel circuit 131 of the display apparatus 101.

The pixel circuit 131 has a content current drive circuit 151, an initialization circuit 152, a signal input circuit 153, a switching circuit 154, a light-emitting device 155, and a switching transistor SW1. The constant current PWM drive of the light-emitting device 155 is executed by the constant current drive circuit 151, the initialization circuit 152, the signal input circuit 153, the switching circuit 154, and the switching transistor SW1.

The constant current drive circuit 151 is a circuit configured to make constant current Iled flow to the light-emitting device 155 via the switching transistor SW1. To the constant current drive circuit 151, an operation power with fixed or variable voltage is supplied from a power supply arranged in the power supply control block 115. In addition, bias voltage Vb for specifying the value of current Iled is applied to the constant current drive circuit 151 from a bias power supply arranged in the power supply control block 115.

It should be noted that, as will be described later, some constant current drive circuits 151 execute the correction of the threshold voltage and mobility of the drive transistor operating as a constant current source for supplying current Iled, while others do not execute this corrective operation.

The initialization circuit 152 is a circuit configured to initialize the potential at point A, namely, the gate voltage of the switching transistor SW1, to reset voltage Vreset.

The signal input circuit 153 is a circuit configured to enter video signal SIG supplied from the video signal supply block 112 and ramp signal Ramp supplied from the scan control block 113 into the switching circuit 154.

The switching circuit 154 is a circuit configured to control the gate voltage of the switching transistor SW1 in order to switch between on and off of the switching transistor SW1.

It should be noted that, as will be described later, some switching circuits 154 execute the correction of the threshold voltage of the switching transistor SW1 in order to switch between on and off of the switching transistor SW1, while others do not execute this corrective operation.

The switching transistor SW1 is made up of an N-channel type transistor. The switching transistor SW1 is turned on or off under the control of the switching circuit 154 to open or close the electrical connection between the drive transistor arranged in the constant current drive circuit 151 and the light-emitting device 155, thereby controlling the supply of current Iled to the light-emitting device 155.

The light-emitting device 155 is made up of a self-light-emission type light-emitting device, such as an organic EL device, a light-emitting diode, or an inorganic EL device, for example.

### <4. First Embodiment of the Pixel Circuit>

### [Circuit Configuration]

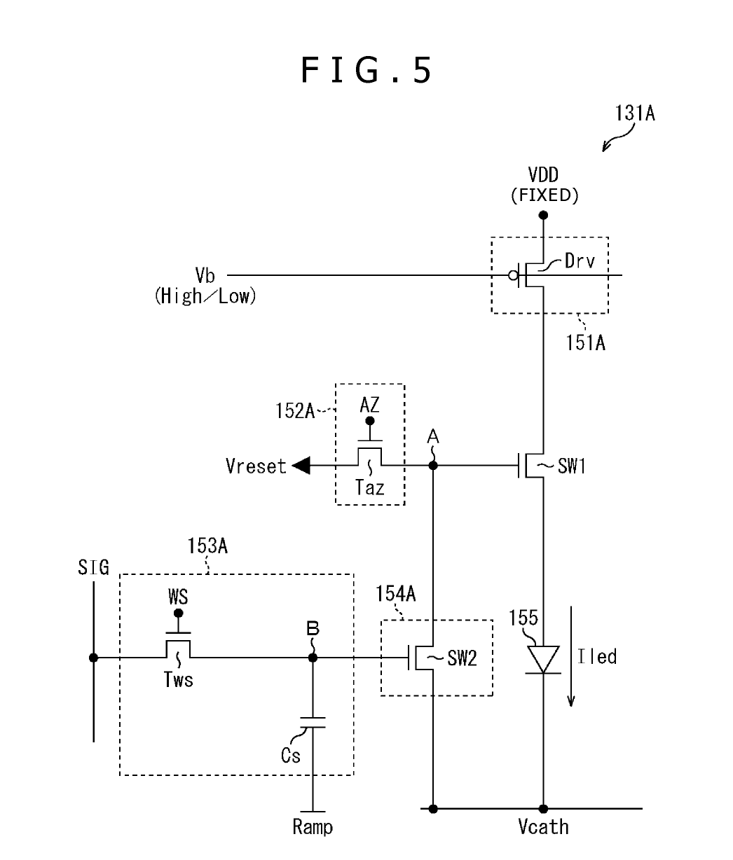

Referring to FIG. 5, there is shown an exemplary configuration of a pixel circuit 131A practiced as the first embodiment of the pixel circuit 131.

The pixel circuit 131A has a constant current drive circuit 151A, an initialization circuit 152A, a signal input circuit 153A, a switching circuit 154A, a switching transistor SW1, and a light-emitting device 155.

The constant current drive circuit 151A is made up of a P-channel type drive transistor Drv.

The drain of the drive transistor Drv is connected to power supply VDD included in the power supply control block 115 to be applied with fixed voltage VDD. The gate of the drive transistor Drv is connected to the bias power supply included in the power supply control block 115 to be applied with bias voltage Vb(High) or Vb(Low). The source of the drive transistor Drv is connected to the drain of the switching transistor SW1.

The initialization circuit 152A is made up of an N-channel type initialization transistor Taz.

The drain of the initialization transistor Taz is connected to the reset power supply included in the power supply control block 115 to be applied with reset voltage Vreset. The gate of the initialization transistor Taz is applied with gate signal AZ from the transistor control block 114. The source of the initialization transistor Taz is connected to point A.

The signal input circuit 153A is made up of an N-channel type write transistor Tws and a capacitor Cs.

The drain of the write transistor Tws is applied with video signal SIG from the video signal supply block 112. The gate of the write transistor Tws is applied with gate signal WS from the transistor control block 114. The source of the write transistor Tws is connected to point B.

One end of the capacitor Cs is connected to point B and the other end is applied with ramp signal Ramp from the scan control block 113.

The switching circuit 154A is made up of an N-channel type switching transistor SW2.

The drain of the switching transistor SW2 is connected to point A (equivalent to the gate of the switching transistor SW1) and the gate is connected to point B. The source of the switching transistor SW2 is connected to the cathode of the light-emitting device 155 and applied with fixed voltage Vcath from the power supply control block 115.

The switching transistor SW2 opens or closes the electrical connection between the gate of the switching transistor SW1 and a predetermined potential (voltage Vcath) that turns off the switching transistor SW1 by video signal SIG entered from the signal input circuit 153 and ramp signal Ramp.

The gate of the switching transistor SW1 is connected to point A and the source is connected to the anode of the light-emitting device 155.

As described above, the pixel circuit 131A is configured to include five transistors and one capacitor.

It should be noted that, in what follows, a gate voltage between the gate and source of the drive transistor Drv is noted as Vgs(Drv) and a threshold voltage is noted as Vth(Drv). Further, in what follows, a gate voltage between the gate and source of the switching transistor SW1 is noted as Vgs(SW1) and a threshold voltage is noted as Vth(SW1). Still further, in what follows, a gate voltage between the gate and source of the switching transistor SW2 is noted as Vgs(SW2) and a threshold voltage is noted as Vth(SW2). Also, in what follows, a threshold voltage of a light-embittering device is noted as Vth(led).

### [Driving Method]

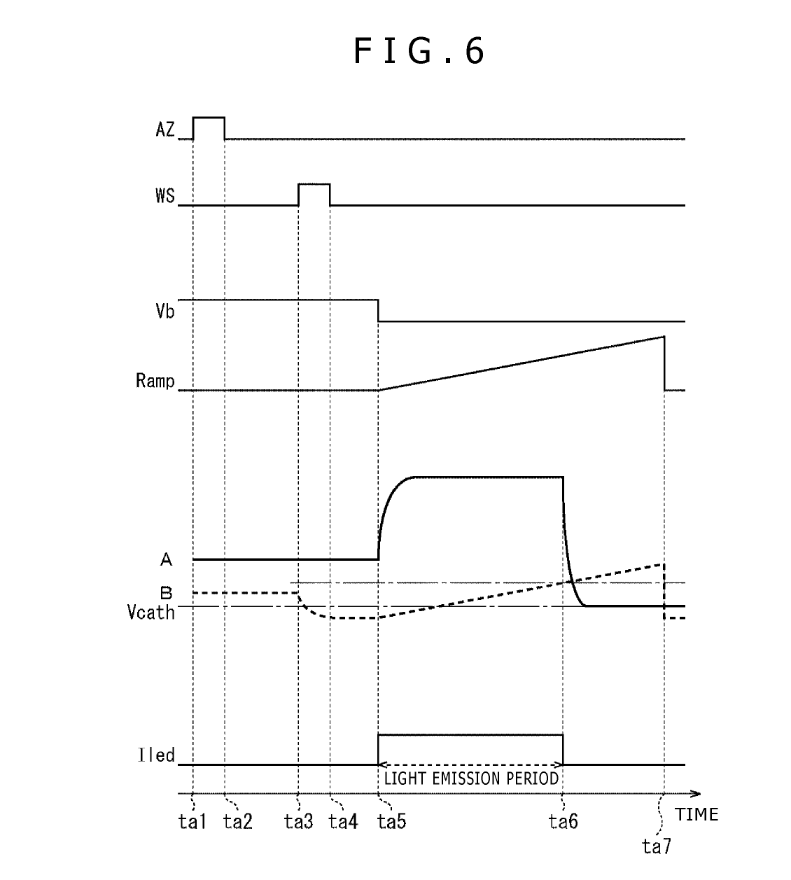

The following describes a method of driving the pixel circuit 131A with reference to the flowchart shown in FIG. 6.

It should be noted that a state of the pixel circuit 131A immediately before time ta1 is as shown below.

The bias voltage is set to Vb(High) and the drive transistor Drv is off. Therefore, current Iled does not flow to the light-emitting device 155, putting the light-emitting device 155 in a light-off state.

The initialization transistor Taz, the write transistor Tws, and the switching transistor SW2 are all off.

The switching transistor SW1 may be off or on because the drive transistor Drv is off.

At time ta1, gate signal AZ goes High, turning on the initialization transistor Taz. Consequently, the potential at point A is set to reset voltage Vreset.

It should be noted that the switching transistor SW1 may be turned on or may not turned off when the potential at point A is set to reset voltage Vreset.

At time ta2, gate signal AZ goes Low, turning off the initialization transistor Taz.

At time ta3, gate signal WS goes High, turning on the write transistor Tws. At this moment, video signal SIG is at signal voltage Vsig corresponding to the luminance of the pixel and the potential at point B is set to signal voltage Vsig.

At time ta4, gate signal WS goes Low, turning off the write transistor Tws.

At time ta5, the bias voltage goes Vb(Low), turning on the drive transistor Drv. Consequently, the potential at the source (the drain of the switching transistor SW1) of the drive transistor Drv approximately goes up to voltage VDD. At the same time, the potential at point A goes up via the capacitor between the drain and gate of the switching transistor SW1. Consequently, gate voltage Vgs(SW1) of the switching transistor SW1 exceeds threshold voltage Vth(SW1), causing the switching transistor SW1 to turn on at least at this moment.

Then, constant current Iled specified by bias voltage Vb(Low) begins to flow to the light-emitting device 155 with the drive transistor Drv as a constant current source, thereby causing the light-emitting device 155 to emit light.

At the same time, the input of ramp signal Ramp into the capacitor Cs starts. Ramp signal Ramp is a signal with the voltage going up at a predetermined slope. As the voltage of ramp signal Ramp goes up, the potential at point B goes up from the initial voltage (signal voltage Vsig) via the capacitor Cs in a slope manner.

Next, at time ta6, when the potential at point B exceeds Vth(SW2)+Vcath and gate voltage Vgs(SW2) of the switching transistor SW2 exceeds threshold voltage Vth(SW2), the switching transistor SW2 is turned on.

Then, when the switching transistor SW2 is turned on, point A and the potential line of voltage Vcath are electrically interconnected to set the potential at point A to voltage Vcath, setting gate voltage Vgs(SW1) of the switching transistor SW1 approximately to 0. Therefore, the switching transistor SW1 is instantaneously cut off without operating in the saturated region.

Consequently, the supply of current Iled to the light-emitting device 155 is instantaneously stopped, upon which the light-emitting device 155 instantaneously moves from the light emission state to the light-off state. Therefore, in a period between time ta5 and time ta6 in which the light-emitting device 155 emits light, current Iled can be kept approximately at a constant level, thereby executing an ideal constant current PWM drive operation. Consequently, the image quality of the display apparatus 101 is enhanced.

It should be noted that, because the slope of ramp signal Ramp is constant, the period from the beginning of the input of ramp signal Ramp to the reaching of the potential at point B to Vth(SW)+Vcath is determined by the potential (the initial voltage) of point B at the time of the beginning of the input of ramp signal Ramp. Because the initial voltage is determined by signal voltage Vsig, the light emission period of the light-emitting device 155 is determined by signal voltage Vsig.

Next, at time ta7, the input of ramp signal Ramp is stopped and the potential at point B changes substantially the same potential as the potential at time ta5 as it was before the input of ramp signal Ramp. Consequently, the switching transistor SW2 is turned off.

### <5. Second Embodiment of the Pixel Circuit (Example of Correcting Switching Transistor Threshold Voltage)>

### [Circuit Configuration]

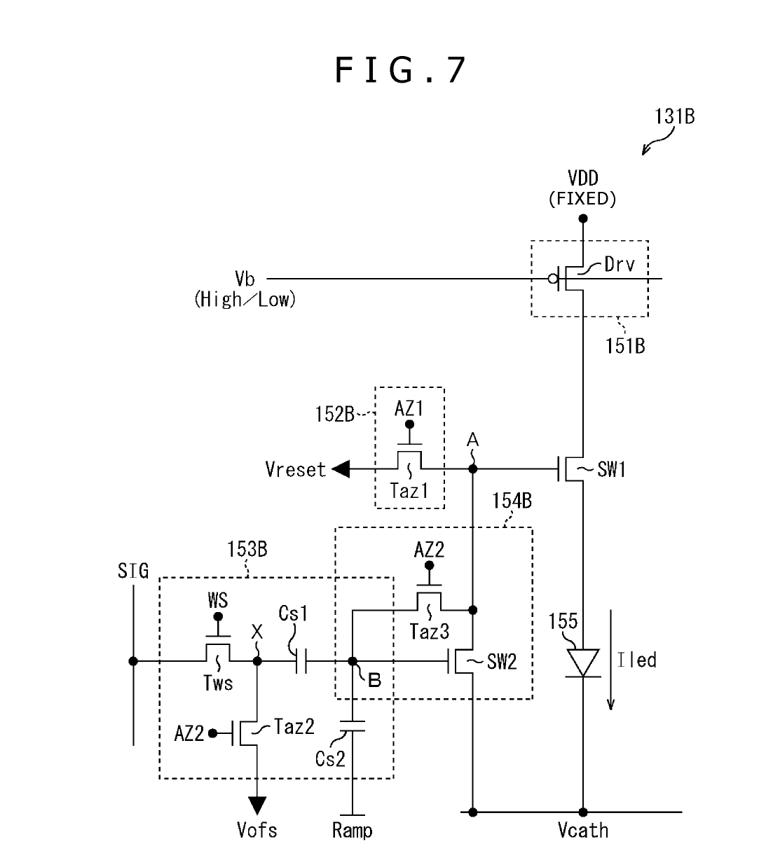

Referring to FIG. 7, there is shown an exemplary configuration of a pixel circuit 131B practiced as the second embodiment the pixel circuit 131.

Threshold voltage Vth(SW2) of the switching transistor SW2 varies from device to device. This variation in this threshold voltage Vth(SW2) varies the timing with which the switching transistor SW2 turns on for the same signal voltage Vsig, resulting in a variation in the light emission period of the light-emitting device 155 from pixel to pixel. Consequently, there occurs a variation in luminance characteristics from pixel to pixel, resulting in degraded image quality.

On the other hand, the pixel circuit 131B corrects the variation in threshold voltage Vth(SW2) of the switching transistor SW2 to cancel the variation in the light emission period between pixels for the same signal voltage Vsig.

The pixel circuit 131B differs from the pixel circuit 131A shown in FIG. 5 that a constant current drive circuit 151B, an initialization circuit 152B, a signal input circuit 153B, and a switching circuit 154B are arranged instead of the constant current drive circuit 151A, the initialization circuit 152A, the signal input circuit 153A, and the switching circuit 154A.

The constant current drive circuit 151B and the initialization circuit 152B have substantially the same functions as those of the constant current drive circuit 151A and the initialization circuit 152A of the pixel circuit 131A.

It should be noted that the reference codes of the components of the initialization circuit 152B are changed from those of the initialization circuit 152A. To be more specific, the initialization transistor Taz is changed to an initialization transistor Taz1 and gate signal AZ is changed to gate signal AZ1.

The signal input circuit 153B has an N-channel type write transistor Tws, an N-channel type initialization transistor Taz2, and capacitors Cs1 and Cs2.

The drain of the write transistor Tws is applied with video signal SIG from the video signal supply block 112. The gate of the write transistor Tws is applied with gate signal WS from the transistor control block 114. The source of the write transistor Tws is connected to point X.

The drain of the initialization transistor Taz2 is connected to the offset power supply included in the power supply control block 115 to be applied with offset voltage Vofs. The gate of the initialization transistor Taz2 is applied with gate signal AZ2 from the transistor control block 114. The source of the initialization transistor Taz2 is connected to point X.

The capacitor Cs1 is connected between point X and point B.

One end of the capacitor Cs2 is connected to point B, while the other end is applied with ramp signal Ramp from the scan control block 113.

The switching circuit 154B is made up of an N-channel type switching transistor SW2 and an N-channel type initialization transistor Taz3.

The drain of the switching transistor SW2 is connected to point A, the gate is connected to point B, and the source is connected to the cathode of the light-emitting device 155 to be applied with voltage Vcath from the power supply control block 115.

The drain of the initialization transistor Taz3 is connected to point A and the source is connected to point B. The gate of the initialization transistor Taz3 is applied with gate signal AZ2 from the transistor control block 114.

As described above, the pixel circuit 131B is configured to include seven transistors and two capacitors.

### [Driving Method]

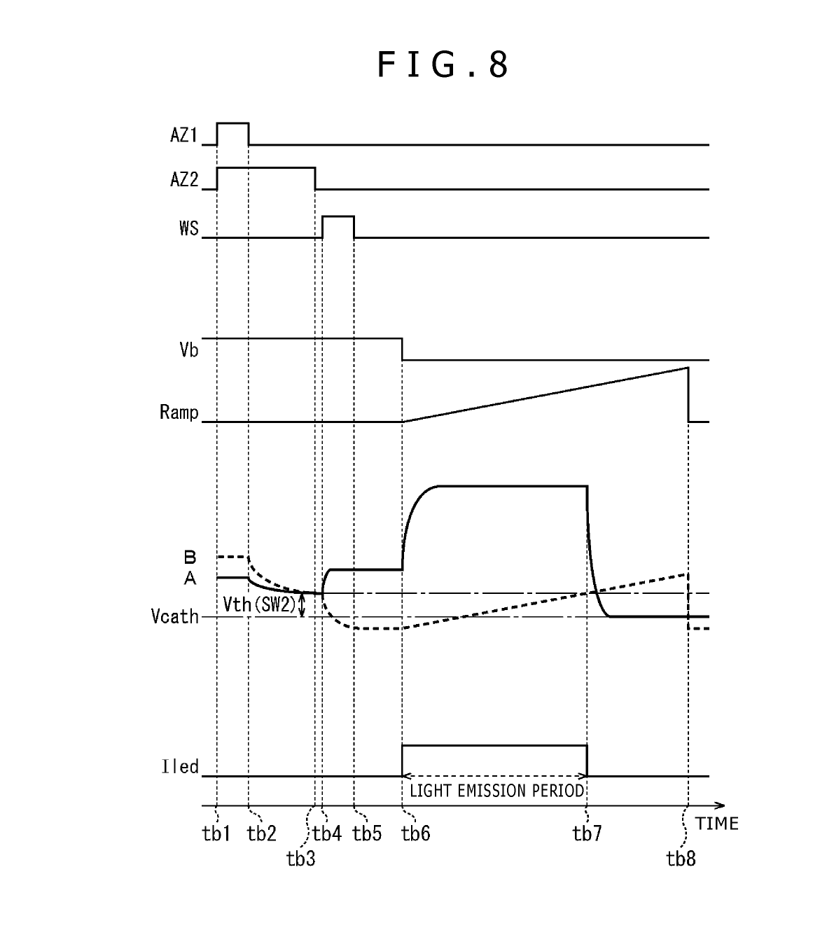

The following describes a method of driving the pixel circuit 131B with reference to the timing chart shown in FIG. 8.

It should be noted that a state of the pixel circuit 131B immediately before time tb1 is as follows.

The bias voltage is set to Vb(High) and the drive transistor Drv is off. Therefore, because current Iled does not flow to the light-emitting device 155, the light-emitting device 155 is in a light-off state.

The initialization transistors Taz1 through Taz3 and the write transistor Tws are off.

Because the drive transistor Drv is off, the switching transistor SW1 may be on or off. The switching transistor SW2 may be on or off.

At time tb1, gate signal AZ1 goes High, thereby turning on the initialization transistor Taz1. Consequently, the potential at point A is set to reset voltage Vreset.

It should be noted that the gate signal WS1 may be turned on or may not be turned on when the potential at point A is set to reset voltage Vreset.

Gate signal AZ2 goes High, thereby turning on the initialization transistors Taz2 and Taz3. When the initialization transistor Taz2 is turned on, the potential at point X is set to offset voltage Vofs, thereby raising the potential at point B via the capacitor Cs2. At this moment, at least the switching transistor SW2 is turned on. When the initialization transistor Taz3 is turned on, a low impedance is caused between point A and point B.

It should be noted that reset voltage Vreset and offset voltage Vofs are set such that the potential at point B becomes higher than the potential at point A.

At time tb2, gate signal Az1 goes Low, turning off the initialization transistor Taz1. Consequently, point A gets in a float state. At the same time, a current begins to flow to the drain (point A) of the switching transistor SW2 from point B via the initialization transistor Taz3. In addition, because the switching transistor SW2 is on to cause a drain current to flow, the potentials at point A and point B begin to lower.

Next, when the potentials at point A and point B reach Vth(SW2)+Vcath to make gate voltage Vgs(SW2) of the switching transistor SW2 be equal to threshold voltage Vth(SW2), the switching transistor SW2 is turned off.

At time tb3, gate signal AZ2 goes Low, thereby turning off the initialization transistors Taz2 and Taz3.

It should be noted that, for an interval between time tb2 and time tb3, a time enough for the potentials at point A and point B to reach Vth(SW2)+Vcath is allocated.

At time tb4, gate signal WS goes High, turning on the write transistor Tws. At this moment, video signal SIG is set to signal voltage Vsig corresponding to the luminance of pixel, in which the potential at point X lowers from offset voltage Vofs to signal voltage Vsig.

Then, with gate voltage Vgs(SW2) of the switching transistor SW2 set to threshold voltage Vth(SW2), signal voltage Vsig is applied to the gate (point B) of the switching transistor SW2 via the capacitor Cs1. Therefore, the potential (or the initial voltage) at point B at the beginning of the light emission period of the light-emitting device 155 is set to a potential based on signal voltage Vsig with reference to threshold voltage Vth(SW2) of the switching transistor SW2. To be more exact, the initial voltage is set to a value obtained by subtracting a voltage corresponding to signal voltage Vsig from Vth(SW2)+Vcath.

Subsequently, at times tb5 and on, a substantially the same operation as that at times ta4 and on shown in FIG. 6 is executed. Then, at time tb6 corresponding time ta5 shown in FIG. 6, the light emission of the light-emitting device 155 begins. When the potential at point B reaches Vth(SW2)+Vcath at time tb7 corresponding to time ta6 shown in FIG. 6, the light emission of the light-emitting device 155 is terminated.

Therefore, the light emission period of the light-emitting device 155 is not dependent on threshold voltage Vth(SW2) of the switching transistor SW2 but determined by signal voltage Vsig alone. This arrangement prevents a variation in the light emission period of the light-emitting device 155 between pixels relative to the same signal voltage Vsig from being caused by a variation in threshold voltage Vth(SW2) of the switching transistor SW2. As a result, the variation in luminance characteristics between pixels is minimized, thereby enhancing the image quality of the display apparatus 101.

### <6. Third Embodiment of the Pixel Circuit (Example of Correcting Drive Transistor Threshold Voltage)>

### [Circuit Configuration]

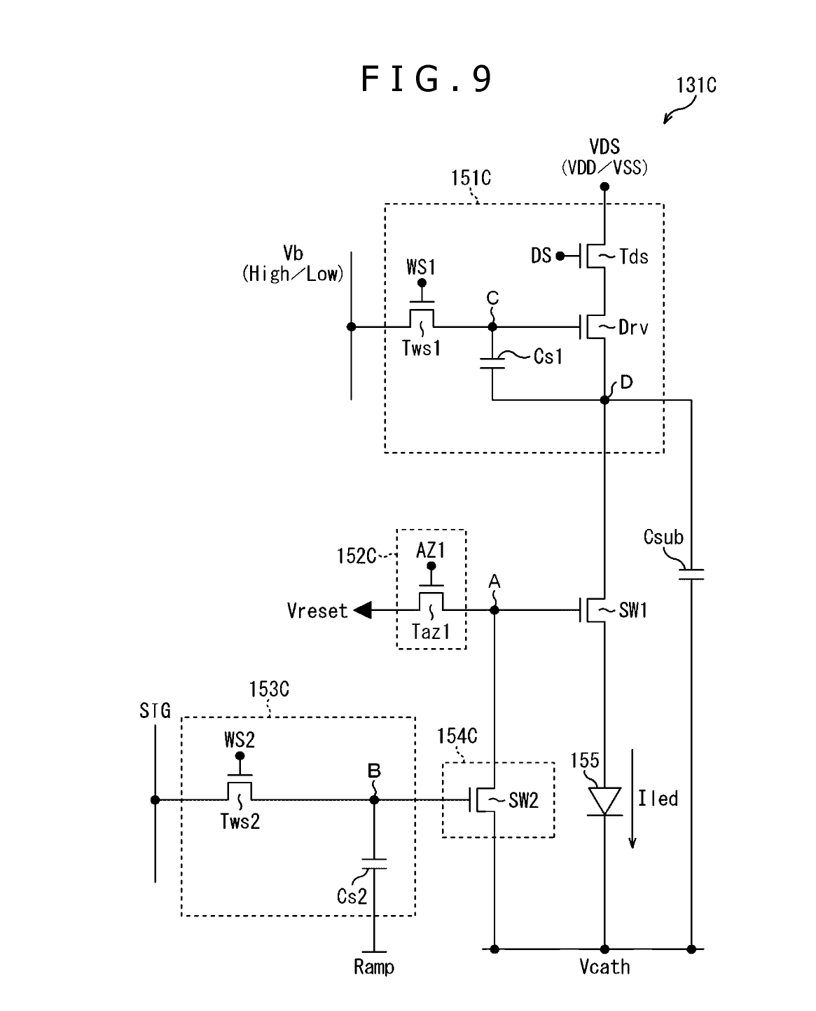

Referring to FIG. 9, there is shown an exemplary configuration of a pixel circuit 131C that is the third embodiment of the pixel circuit 131.

Current Iled flowing through a light-emitting device 155 is approximately equal to drain current Ids(Drv) of a drive transistor Drv, drain current Ids(Drv) being obtained from equations (1) through (3) below.

Ids(Drv)=k·μ(Drv)·(Vgs(Drv)−Vth(Drv))² (1)

k=(½)·(W/L)·Cox (2)

Cox=specific permittivity of gate insulation layer×permittivity of vacuum/thickness of gate insulation layer (3)

It should be noted that μ(Drv) of equation (1) above is indicative of mobility of the drive transistor Drv. W in equation (2) above is indicative of channel width of the drive transistor Drv and L is indicative of channel length of the drive transistor Drv.

On the other hand, threshold voltage Vth(Drv) of the drive transistor Drv causes a variation for each device. As shown in equation (1) above, drain current Ids(Drv) of the drive transistor Drv depends on threshold voltage Vth(Drv), so that a variation in threshold voltage Vth(Drv) causes a variation in current Iled that flows through the light-emitting device 155. As a result, a variation in the luminance characteristic between pixels is caused, thereby degrading image quality.

On the other hand, the pixel circuit 131C is configured to correct the variation in threshold voltage Vth(Drv) of the drive transistor Drv to cancel the variation, between pixels, in current Iled that flows through the light-emitting device 155.

The pixel circuit 131C differs from the pixel circuit 131A shown in FIG. 5 that a constant current drive circuit 151C, an initialization circuit 152C, a signal input circuit 153C, and a switching circuit 154C are arranged instead of the constant current drive circuit 151A, the initialization circuit 152A, the signal input circuit 153A, and the switching circuit 154A. One more difference is that a capacitor Csub is added to the pixel circuit 131C.

Of these components, the initialization circuit 152C, signal input circuit 153C, and the switching circuit 154C have substantially the same functions as those of the initialization circuit 152A, signal input circuit 153A, and switching circuit 154A of the pixel circuit 131A.

It should be noted that the reference codes of the components of the initialization circuit 152C are changed from those of the initialization circuit 152A. To be more specific, the initialization transistor Taz is changed to an initialization transistor Taz1 and gate signal AZ is changed to gate signal AZ1.

Also, the reference codes of the components of the signal input circuit 153C are changed from those of the signal input circuit 153A. To be more specific, the write transistor Tws is changed to a write transistor Tws2, the gate signal WS is changed to a gate signal WS2, and the capacitor Cs is changed to a capacitor Cs2.

The constant current drive circuit 151C has an N-channel type power supply control transistor Tds, an N-channel type drive transistor Drv, an N-channel type write transistor Tws1, and a capacitor Cs1.

The drain of the power supply control transistor Tds is connected to power supply VDS included in the power supply control block 115 to be applied with voltage VDD or voltage VSS. The gate of the power supply control transistor Tds is applied with gate signal DS from the transistor control block 114. The source of the power supply control transistor Tds is connected to the drain of the drive transistor Drv.

The gate of the drive transistor Drv is connected to point C and the source is connected to point D.

The drain of the write transistor Tws1 is connected to the bias power supply included in the power supply control block 115 to be applied with bias voltage Vb(High) or Vb(Low). The gate of the write transistor Tws1 is applied with gate signal WS1 from the transistor control block 114. The source of the write transistor Tws1 is connected to point C.

The capacitor Cs1 is connected between point C and point D.

The capacitor Csub is connected between point D and the cathode of the light-emitting device 155.

As described above, the pixel circuit 131C is configured to include seven transistors and three capacitors.

### [Driving Method]

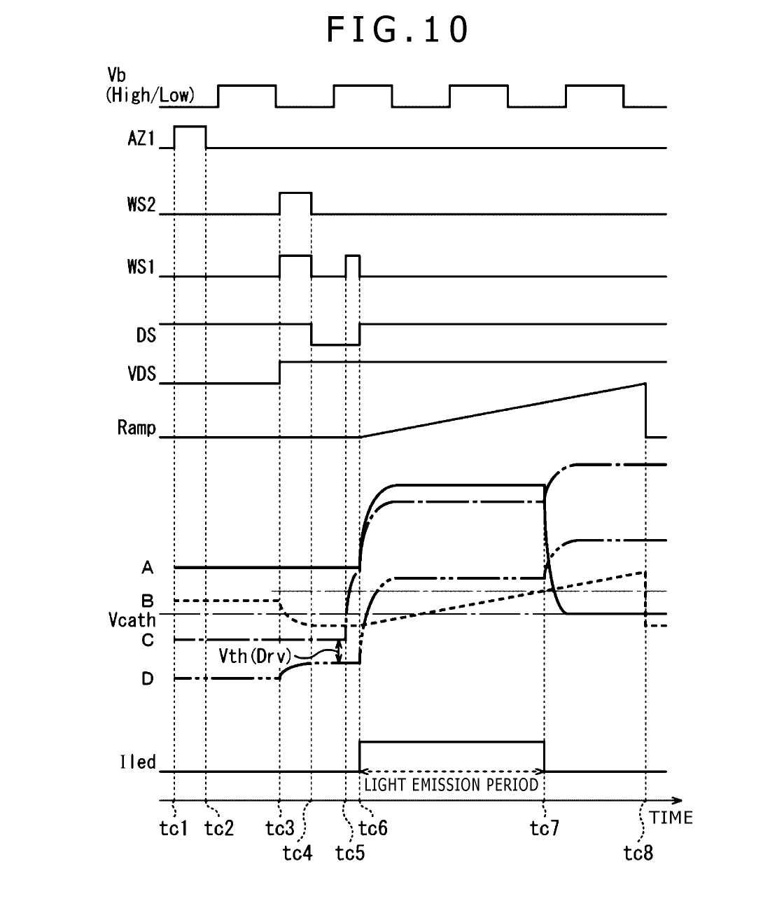

The following describes a method of driving the pixel circuit 131C with reference to the timing chart shown in FIG. 10.

It should be noted that a state of the pixel circuit 131C immediately before time tc1 is as follows.

The drive transistor Drv and the power supply control transistor Tds are on and the voltage of the power supply VDS is set to voltage VSS. Therefore, the potential at point D is set to voltage VSS.

The write transistors Tws1 and Tws2, the initialization transistor Taz1, and the switching transistor SW2 are off.

The switching transistor SW1 may be off or on. If the switching transistor SW1 is off, current Iled does not flow through the light-emitting device 155, so that the light-emitting device 155 is in a light-off state.

On the other hand, if the switching transistor SW1 is on, then voltage VSS is set so as to satisfy relation (4) below to prevent the light-emitting device 155 from emitting light.

VSS<Vth(led)+Vcath (4)

At time tc1, gate signal AZ1 goes High, turning on the initialization transistor Taz1. Consequently, the potential at point A is set to reset voltage Vreset.

It should be noted that the switching transistor SW1 may be turned on or not when the potential at point A is set to reset voltage Vreset. If the switching transistor SW1 is turned on, voltage VSS is set so as to satisfy relation (4) above.

At time tc2, gate signal AZ1 goes Low, turning off the initialization transistor Taz1.

At time tc3, gate signal WS1 goes High when the bias voltage is set to Vb(Low), thereby turning on the write transistor Tws1. Consequently, the potential at point C is set to bias voltage Vb(Low).

It should be noted that bias voltage Vb(Low) is set to a value at which the drive transistor Drv is not turned off.

At the same time, the voltage of power supply VDS is switched from voltage VSS to voltage VDD. Consequently, the potential at point D goes up with the potential at point C maintained at bias voltage Vb(Low). Then, when the potential at point D reaches Vb(Low)-Vth(Drv) to cause gate voltage Vgs(Drv) of the drive transistor Drv to reach threshold voltage Vth(Drv), the drive transistor Drv is turned off.

It should be noted that, if the switching transistor SW1 is on at this point time, then bias voltage Vb(Low) is set so as to satisfy relation (5) below in order to prevent the light-emitting device 155 from emitting light.

Vb(Low)−Vth(Drv)<Vth(led)+Vcath (5)

Further, the gate signal WS2 goes High, turning on the write transistor Tws2. At this moment, video signal SIG has been set to signal voltage Vsig corresponding to the luminance of the pixel and the potential at point B is set to signal voltage Vsig.

At time tc4, gate signals WS1, WS2, and DS go Low, turning off the write transistors Tws1 and Tws2, and the power supply control transistor Tds.

It should be noted that, for an interval between time tc3 and time tc4, a time enough for the potential at point D to reach Vb(Low)−Vth(Drv) is allocated.

At time tc5, when the bias voltage has been set to Vb(High), gate signal WS1 goes High, thereby turning on the write transistor Tws1. Consequently, the potential at point C is set to bias voltage Vb(High). As a result, gate voltage Vgs(Drv) of the drive transistor Drv is set to a value indicated by equation (6) below.

Vgs(Drv)=Vb(High)−(Vb(Low)−Vth(Drv))=Vth(Drv)+(Vb(High)−Vb(Low)) (6)

To be more specific, gate voltage Vgs(Drv) of the drive transistor Drv is set to a value obtained by adding a predetermined bias voltage (Vb(High)−Vb(Low)) to threshold voltage Vth(Drv). Then, gate voltage Vgs(Drv) of the drive transistor Drv exceeds threshold voltage Vth(Drv) to turn on the drive transistor Drv.

At time tc6, gate signal WS1 goes Low, turning off the write transistor Tws1. Consequently, the gate (point C) of the drive transistor Drv gets in a float state.

AT the same time, gate signal DS goes High, turning on the power supply control transistor Tds. Consequently, voltage VDD is applied to the drain of the drive transistor Drv with the drive transistor Drv kept in the on state, so that the potential at point D goes up beyond Vth(led)+Vcath.

Because the gate (point C) of the drive transistor Drv is in the float state, the potential at point C goes up via the capacitor Cs1 in substantially the same phenomenon as a so-called bootstrap circuit. As a result, gate voltage Vgs(Drv) of the drive transistor Drv holds the value indicated by equation (6) above.

Further, the rise of the potential at point D causes the potential at point A to go up via the capacitor between the drain and gate of the switching transistor SW1. Consequently, gate voltage Vgs(SW1) of the switching transistor SW1 exceeds threshold voltage Vth(SW1), upon which the switching transistor SW1 is turned on at least at this point of time.

Then, current Iled begins to flow through the light-emitting device 155 with the drive transistor Drv being a constant current source, upon which the light-emitting device 155 beings emitting light.

It should be noted that a value of drain current Ids(Drv) of the drive transistor Drv at this point of time is expressed by equation (7) below by substituting gate voltage Vgs(Drv) of equation (6) into equation (1) above.

Ids(Drv)=k·μ(Drv)·(Vb(High)−Vb(Low))² (7)

As described above, setting gate voltage Vgs(Drv) to the value indicated by equation (6) allows drain current Ids(Drv) to be independent of threshold voltage Vth(Drv) of the drive transistor Drv as shown in equation (7) above.

As a result, current Iled flowing through the light-emitting device 155 is not varied by threshold voltage Vth(Drv) of the drive transistor Drv, thereby minimizing the variation in the luminance characteristic between pixels, which leads to the enhanced image quality of the display apparatus 101.

At the same time, the input of ramp signal Ramp into the capacitor Cs2 begins and, as the voltage of the ramp signal Ramp goes up, the potential at point B goes up in a slope manner via the capacitor Cs2.

Then, at time tc7, as with time ta6 shown in FIG. 6, when the potential at point B exceeds Vth(SW2)+Vcath, the switching transistor SW2 is turned on, instantaneously turning off the switching transistor SW1. Consequently, the supply of current Iled to the light-emitting device 155 is instantaneously stopped, upon which the light-emitting device 155 moves from the light emission state to the light-off state.

### <7. First Variation to the Pixel Circuit Practiced as the Third Embodiment>

### [Circuit Configuration]

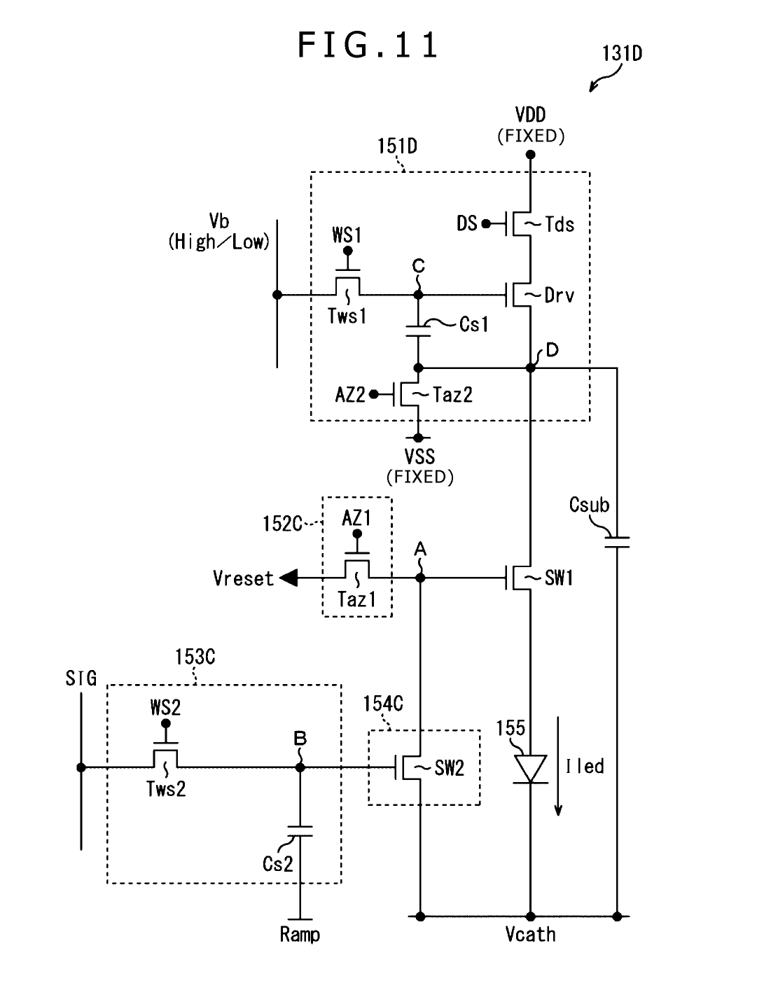

Referring to FIG. 11, there is shown an exemplary configuration of a pixel circuit 131D that is the first variation to the pixel circuit 131C shown in FIG. 9.

The pixel circuit 131D differs from the pixel circuit 131C shown in FIG. 9 that a constant current drive circuit 151D is arranged instead of the constant current drive circuit 151C.

The constant current drive circuit 151D has a configuration in which an N-channel type initialization transistor Taz2 is added to the constant current drive circuit 151C shown in FIG. 9.

The drain of the initialization transistor Taz2 is connected to power supply VSS included in the power supply control block 115 to be applied with fixed voltage VSS. The gate of the initialization transistor Taz2 is applied with gate signal AZ2 from the transistor control block 114. The source of the initialization transistor Taz2 is connected to point D.

The drain of the power supply control transistor Tds is connected to the power supply VDD included in the power supply control block 115 to be applied with fixed voltage VDD, instead of the power supply VDS.

As described above, the pixel circuit 131D is configured to include eight transistors and three capacitors.

### [Driving Method]

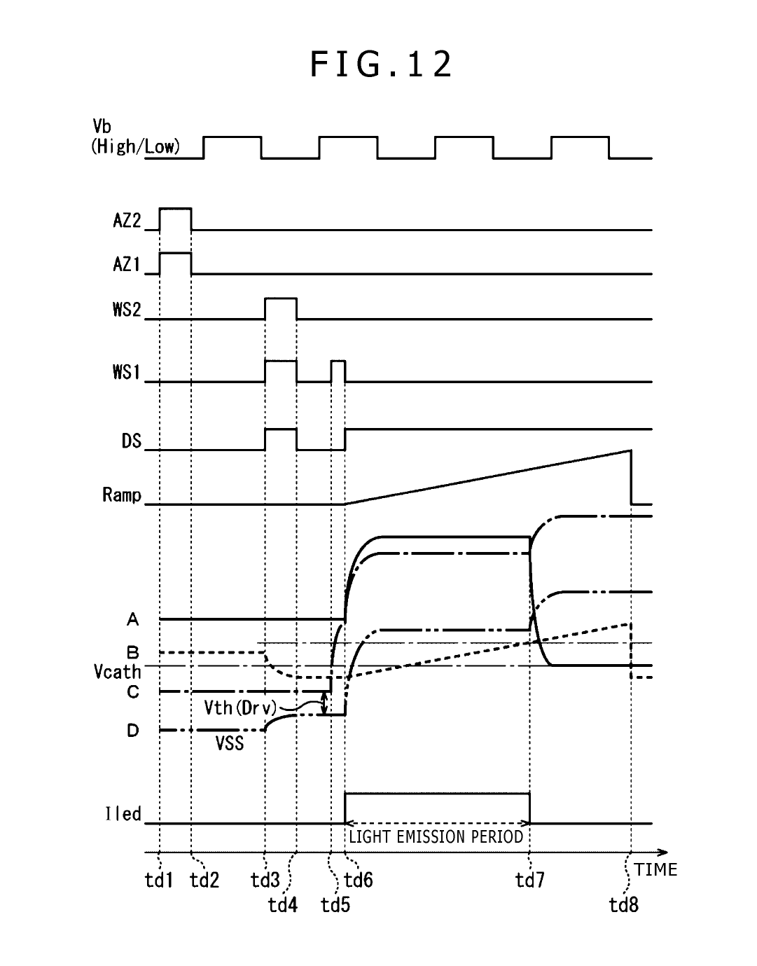

The following describes a method of driving the pixel circuit 131D with reference to the timing chart shown in FIG. 12.

The timing chart shown in FIG. 12 differs from the timing chart shown in FIG. 10 only in an operation of setting the potential at point D between time td1 and time td3.

To be more specific, in the pixel circuit 131C, the potential at point D is set by controlling the voltage of power supply VDS and gate signal DS, while, in the pixel circuit 131D, the potential at point D is set by controlling gate signal DS and gate signal AZ2.

To be more specific, at time td1, gate signal AZ2 goes High, turning on the initialization transistor Taz2. Consequently, the potential at point D is set to voltage VSS. Because point C is in the float state, the potential at point C also varies via the capacitor Cs1 when the potential at point D is set to voltage VSS.

Then, at time td2, gate signal AZ2 goes Low, turning off the initialization transistor Taz2.

At td3, gate signal DS goes High, turning on the power supply control transistor Tds. Consequently, as with the case of time tc3 shown in FIG. 10, the potential at point D goes up with the potential at point C maintained at bias voltage Vb(Low). Then, when the potential at point D reaches Vb(Low)−Vth(Drv) and gate voltage Vgs(Drv) of the drive transistor Drv becomes equal to threshold voltage Vth(Drv), the drive transistor Drv is turned off.

The other operations are substantially the same as those of the pixel circuit 131C.

### <8. Second Variation to the Pixel Circuit Practiced as the Third Embodiment>

### [Circuit Configuration]

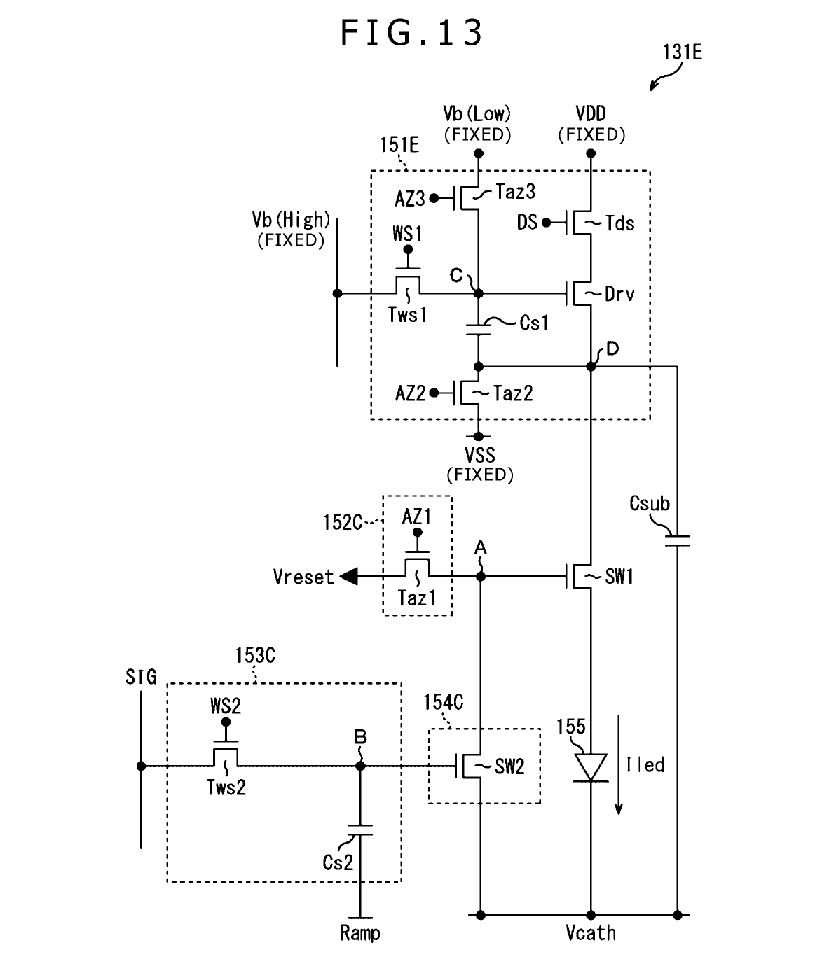

Referring to FIG. 13, there is shown an exemplary configuration of a pixel circuit 131E that is the second variation to the pixel circuit 131C.

The pixel circuit 131E differs from the pixel circuit 131D shown in FIG. 11 that a constant current drive circuit 151E is arranged instead of the constant current drive circuit 151D.

The constant current drive circuit 151E has a configuration in which an N-channel type initialization transistor Taz3 is added to the constant current drive circuit 151D shown in FIG. 11.

The drain of the initialization transistor Taz3 is connected to the bias power supply included in the power supply control block 115 to be applied with fixed bias voltage Vb(Low). The gate of the initialization transistor Taz3 is applied with gate signal AZ3 from the transistor control block 114. The source of the initialization transistor Taz3 is connected to point C.

The drain of the write transistor Tws1 is connected to the bias power supply included in the power supply control block 115 to be applied with fixed bias voltage Vb(High).

As described above, the pixel circuit 131E is configured to include nine transistors and three capacitors.

### [Driving Method]

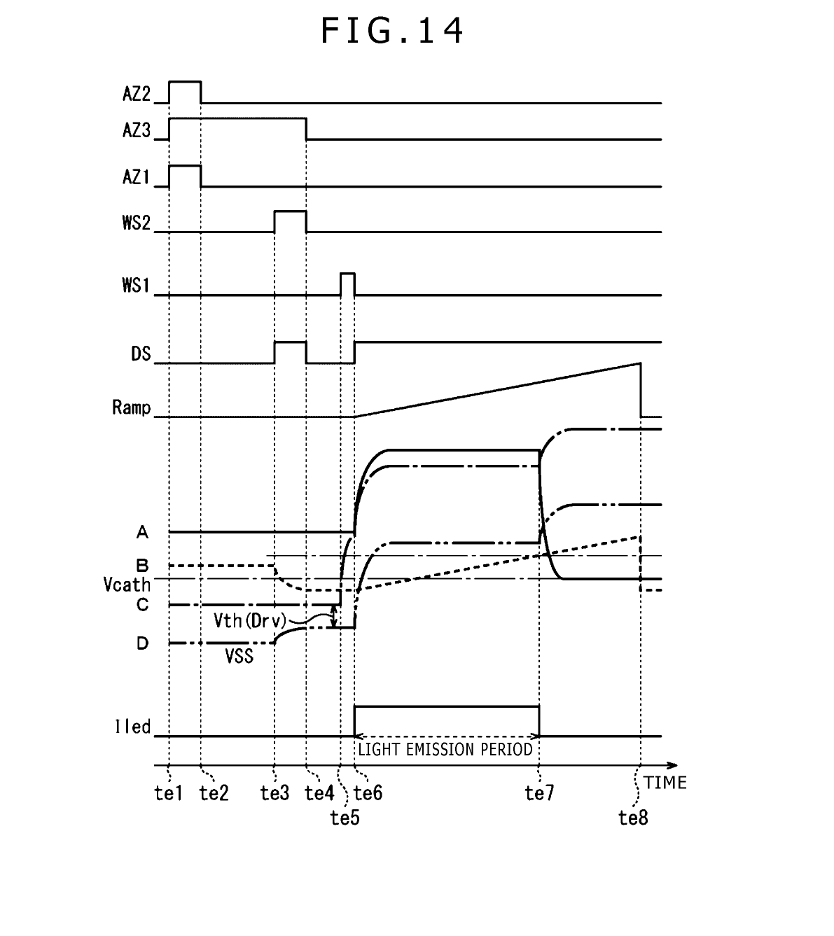

The following described a method of driving the pixel circuit 131E with reference to the timing chart shown in FIG. 14.

The timing chart shown in FIG. 14 differs from the timing chart shown in FIG. 12 only in the operation of setting the potential at point C at time te1 through time te6.

To be more specific, in the pixel circuit 131D, the potential at point C is set by controlling the voltage of bias power supply and gate signal WS1, while, in the pixel circuit 131E, the potential at point C is set by controlling gate signal WS1 and gate signal AZ3.

To be more specific, at time te1, gate signal AZ3 goes High, turning on the initialization transistor Taz3. Consequently, the potential at point C is set to bias voltage Vb(Low).

Then, at time te4, gate signal AZ3 goes Low, turning off the initialization transistor Taz3.

At time te5, gate signal WS1 goes High, turning on the write transistor Tws1. Consequently, the potential at point C is set to bias voltage Vb(High).

Then, at time te6, gate signal WS1 goes Low, turning off the write transistor Tws1. Consequently, the gate (point C) of the drive transistor Drv gets in a float state.

The other operations are substantially the same as those of the pixel circuit 131D.

### <9. Fourth Embodiment of the Pixel Circuit (Example of Correcting Drive Transistor and Switch Transistor Threshold Voltage)>

### [Circuit Configuration]

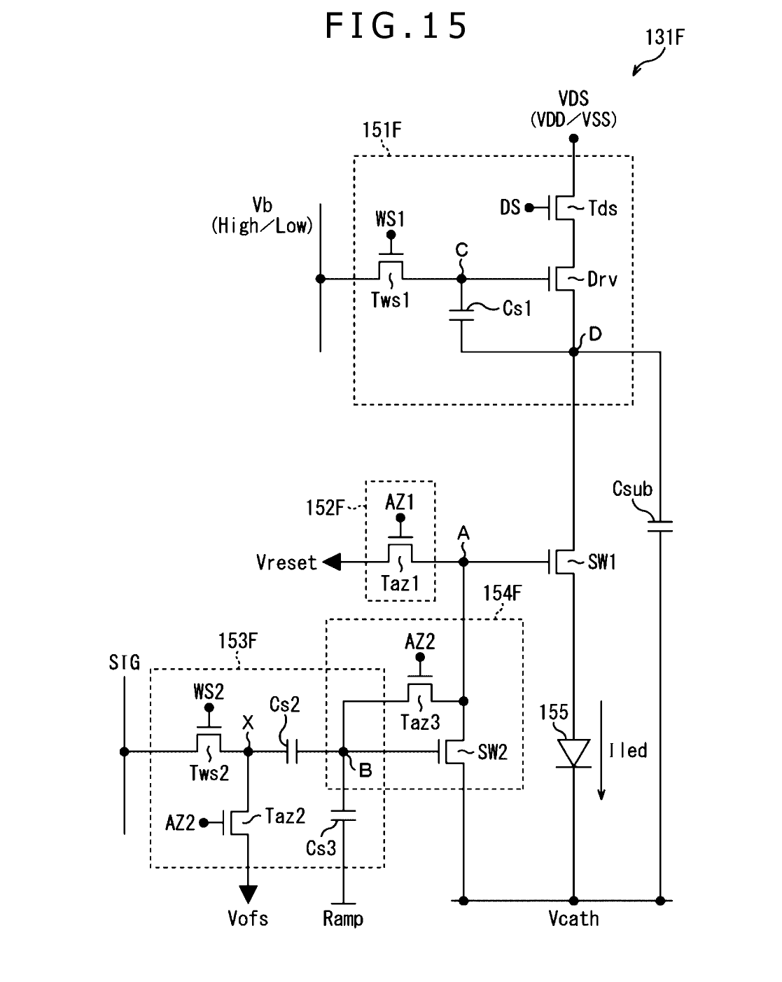

Referring to FIG. 15, there is shown an exemplary configuration of a pixel circuit 131F that is the fourth embodiment of the pixel circuit 131.

The pixel circuit 131F is configured to correct both the variations in threshold voltage Vth(Drv) of the drive transistor Drv and threshold voltage Vth(SW2) of the switching transistor SW2.

The pixel circuit 131F has a configuration in which the pixel circuit 131B shown in FIG. 7 and the pixel circuit 131C shown in FIG. 9 are combined together.

To be more specific, the pixel circuit 131F has a constant current drive circuit 151F, an initialization circuit 152F, a signal input circuit 153F, a switching circuit 154F, a light-emitting device 155, a switching transistor SW1 and a capacitor Csub.

Of the above-mentioned components, the constant current drive circuit 151F has substantially the same configuration as that of the constant current drive circuit 151C of the pixel circuit 131 shown in FIG. 9. The initialization circuit 152F, the signal input circuit 153F, and the switching circuit 154F have substantially the same configurations as those of the initialization circuit 152B, the signal input circuit 153B, and the switching circuit 154B of the pixel circuit 131B shown in FIG. 7, respectively.

It should be noted that some of the reference codes of the components of the signal input circuit 153F are changed from those of the signal input circuit 153B. To be more specific, the write transistor Tws is changed to the write transistor Tws2, gate signal WS is changed to gate signal WS2, and the capacitors Cs1 and Cs2 are changed to the capacitors Cs2 and Cs3, respectively.

As described above, the pixel circuit 131F is configured to include nine transistors and four capacitors.

### [Driving Method]

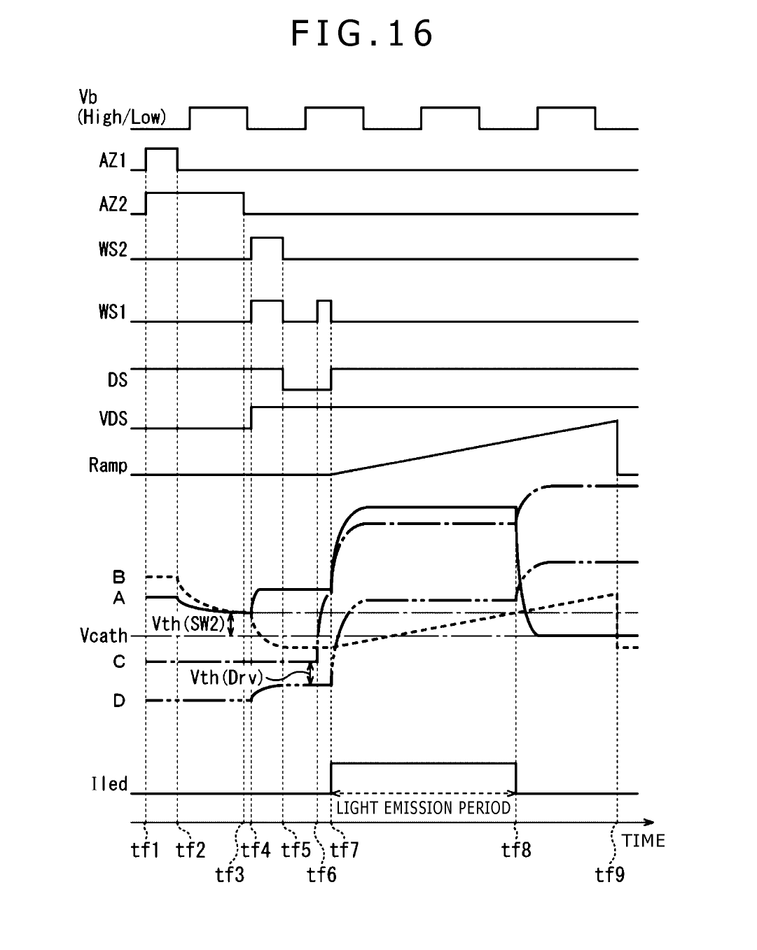

The following describes a method of driving the pixel circuit 131F with reference to the timing chart shown in FIG. 16.

It should be noted that the timing chart shown in FIG. 16 is basically a combination of the timing chart shown in FIG. 8 and the timing chart shown in FIG. 10.

To be more specific, in an interval between time tf1 and time tf3, the initialization circuit 152F, the signal input circuit 153F, and the switching circuit 154F execute substantially the same operations as those done by the initialization circuit 152B, signal input circuit 153B, and the switching circuit 154B shown in FIG. 7 in the interval between time tb1 and time tb3 shown in FIG. 8. Namely, the variation in threshold voltage Vth(SW2) of the switching transistor SW2 is corrected.

Also, in an interval between time tf4 and time tf5, the constant current drive circuit 151F executes substantially the same operation as that done by the constant current drive circuit 151C shown in FIG. 9 in the interval between tc3 and tc4 shown in FIG. 10. Namely, the variation in threshold voltage Vth(Drv) of the drive transistor Drv is corrected.

Then, at times tf6 and on, substantially the same operations as those at times tc5 and on shown in FIG. 10 are executed.

### <10. First Variation to the Pixel Circuit Practiced as the Fourth Embodiment>

### [Circuit Configuration]

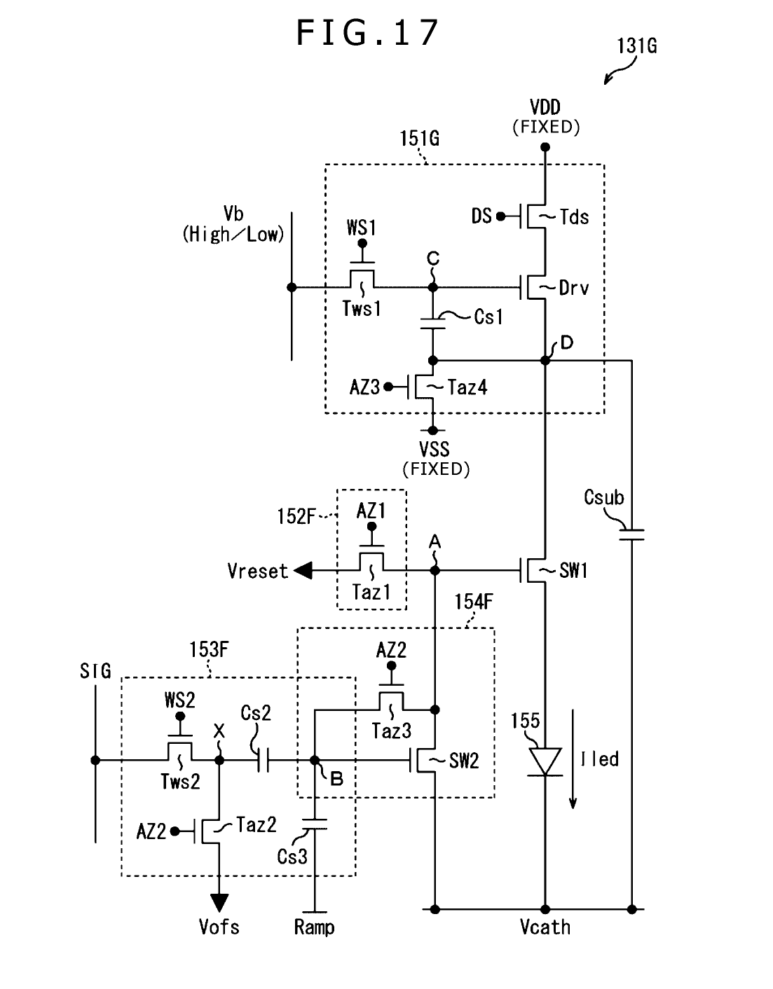

Referring to FIG. 17, there is shown an exemplary configuration of a pixel circuit 131G that is the first variation to the pixel circuit 131F.

The pixel circuit 131G differs from the pixel circuit 131F that a constant current drive circuit 151G is arranged instead of the constant current drive circuit 151F.

The constant current drive circuit 151G has substantially the same configuration as that of the constant current drive circuit 151D of the pixel circuit 131D shown in FIG. 11.

It should be noted that some of the reference codes of the components of the constant current drive circuit 151G are changed from those of the constant current drive circuit 151D. To be more specific, the initialization transistor Taz2 is changed to the initialization transistor Taz4 and gate signal AZ2 is changed to gate signal AZ3.

As described above, the pixel circuit 131G is configured to include ten transistors and four capacitors.

### [Driving Method]

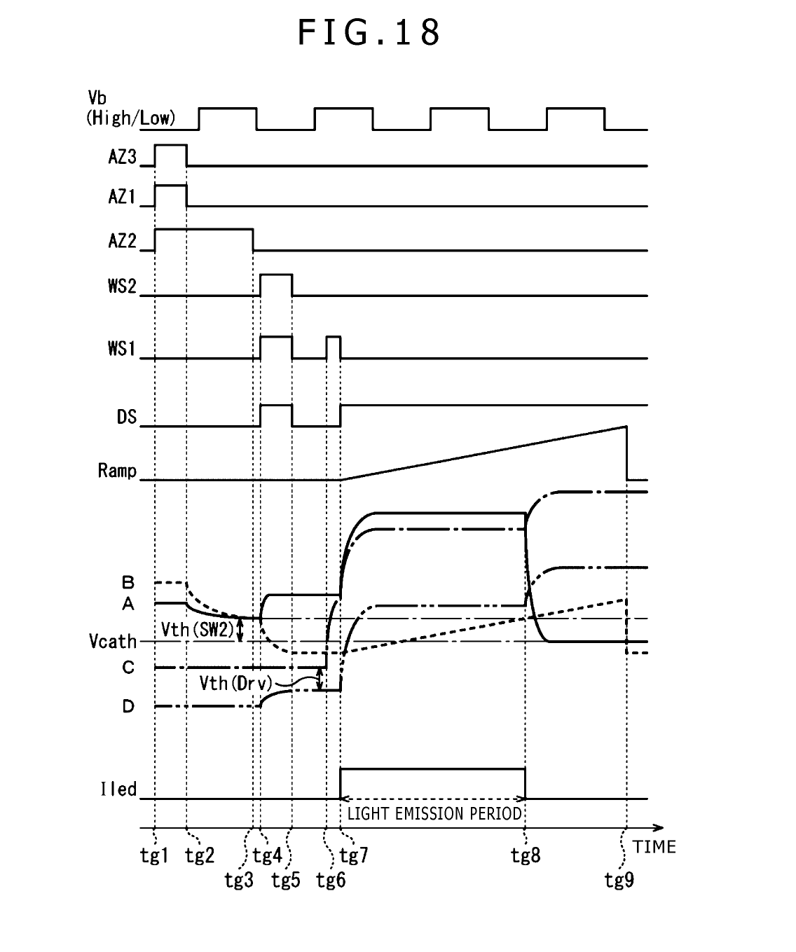

The following describes a method of driving the pixel circuit 131G with reference to the timing chart shown in FIG. 18.

The timing chart shown in FIG. 18 differs the timing chart shown in FIG. 16 only in an operation of setting the potential at point D in an interval between time tg1 and time tg4.

To be more specific, in the pixel circuit 131F, the potential at point D is set by controlling the voltage of power supply VDS and gate signal DS, while, in the pixel circuit 131G, the potential at point D is set by controlling gate signal DS and gate signal AZ3.

To be more specific, at time tg1, gate signal AZ3 goes High, turning on the initialization transistor Taz4. Consequently, the potential at point D is set to voltage VSS. Because point C is in the float state, the potential at point C also varies via the capacitor Cs1 when the potential at point D is set to voltage VSS.

Then, at time tg2, gate signal AZ3 goes Low, turning off the initialization transistor Taz4.

At time tg4, gate signal DS goes High, turning on the power supply control transistor Tds. Consequently, as with the case of time tc3 shown in FIG. 10, the potential at point D goes up with the potential at point C maintained at bias voltage Vb(Low). Then, when the potential at point D reaches Vb(Low)−Vth(Drv) and gate voltage Vgs(Drv) of the drive transistor Drv becomes equal to threshold voltage Vth(Drv), the drive transistor Drv is turned off.

The other operations are substantially the same as those of the pixel circuit 131F.

### <11. Second Variation to the Pixel Circuit Practiced as the Fourth Embodiment>

### [Circuit Configuration]

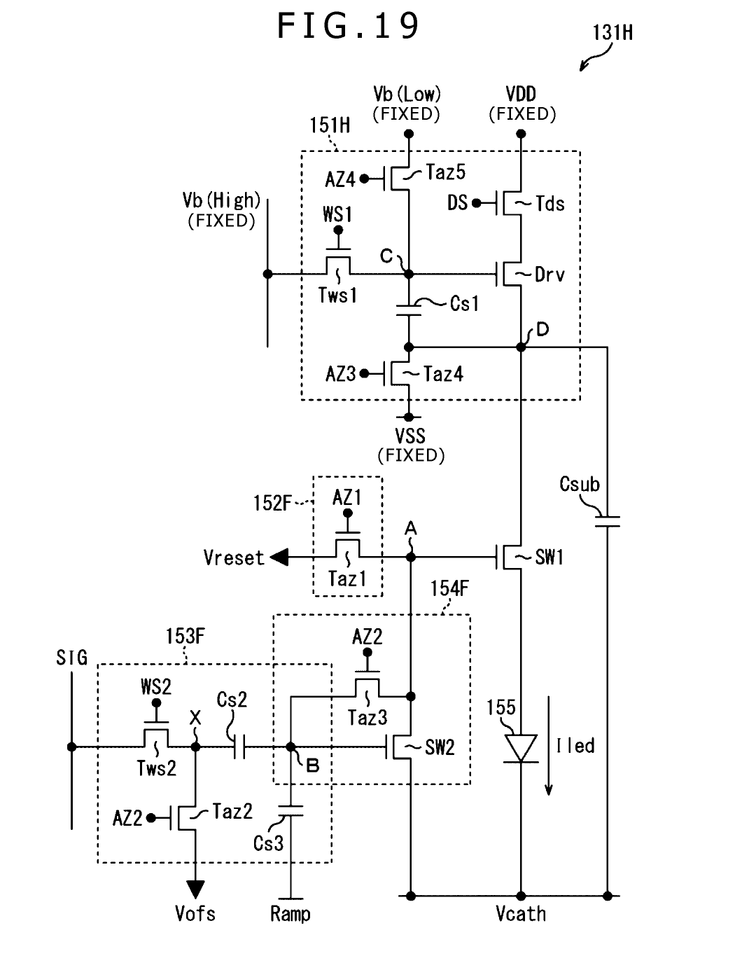

Referring to FIG. 19, there is shown an exemplary configuration of a pixel circuit 131H that is the second variation to the pixel circuit 131F.

The pixel circuit 131H differs from the pixel circuit 131G shown in FIG. 17 that a constant current drive circuit 151H is arranged instead of the constant current drive circuit 151G.

The constant current drive circuit 151H has substantially the same configuration as that of the constant current drive circuit 151E of the pixel circuit 131E shown in FIG. 13.

It should be noted that some of the reference codes of the components of the constant current drive circuit 151H are changed from those of the constant current drive circuit 151E. To be more specific, the initialization transistors Taz2 and Taz3 are changed to the initialization transistors Taz4 and Taz5 and gate signals AZ2 and AZ3 are changed to gate signal AZ3 and AZ4, respectively.

As described above, the pixel circuit 131H is configured to include ten transistors and four capacitors.

### [Driving Method]

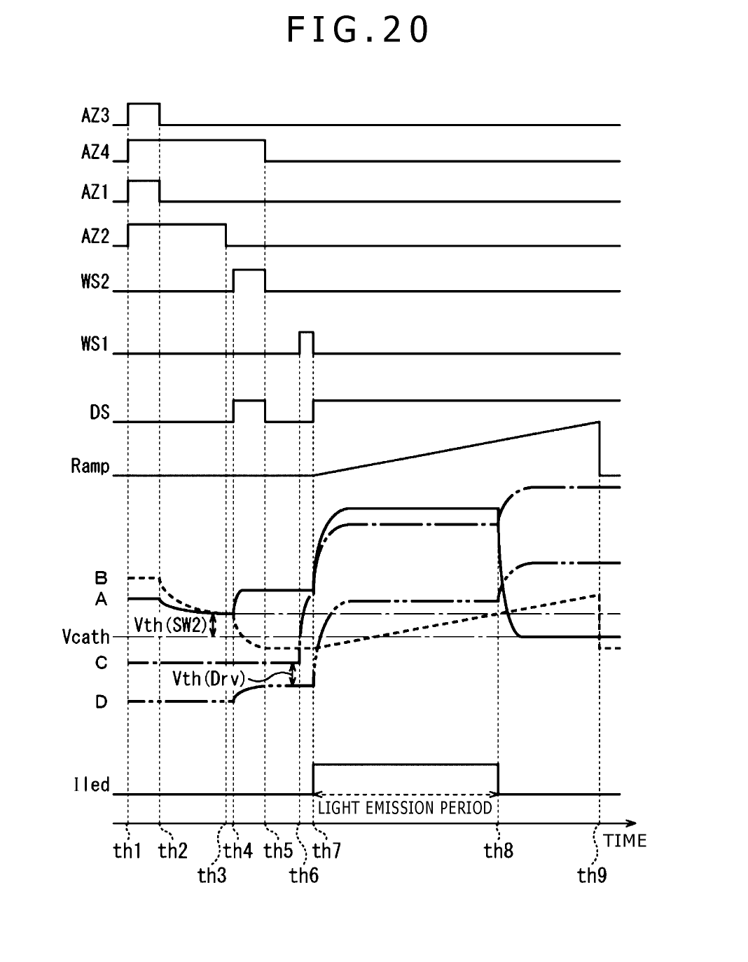

The following describes a method of driving the pixel circuit 131H with reference to the timing chart shown in FIG. 20.

The timing chart shown in FIG. 20 differs from the timing chart shown in FIG. 18 only in an operation of setting the potential at point C in an interval from time th1 to time th7.

Namely, in the pixel circuit 131G, the potential at point C is set by controlling the voltage of bias power supply and gate signal WS1, while, in the pixel circuit 131H, the potential at point C is set by controlling gate signal WS1 and gate signal AZ4.

To be more specific, at time th1, gate signal AZ4 goes High, turning on the initialization transistor Taz5. Consequently, the potential at point C is set to bias voltage Vb(Low).

Then, at time th5, gate signal AZ goes Low, turning off the initialization transistor Taz5.

At time th6, gate signal WS1 goes High, turning on the write transistor Tws1. Consequently, the potential at point C is set to bias voltage Vb(High).

Then, at time th7, gate signal WS1 goes Low, turning off the write transistor Tws1. Consequently, the gate (point C) of the drive transistor Drv gets in a float state.

The other operations are substantially the same as those of the pixel circuit 131G.

### <12. Fifth Embodiment of the Pixel Circuit (Example of Correcting Drive Transistor Threshold Voltage and Mobility)>

### [Circuit Configuration]

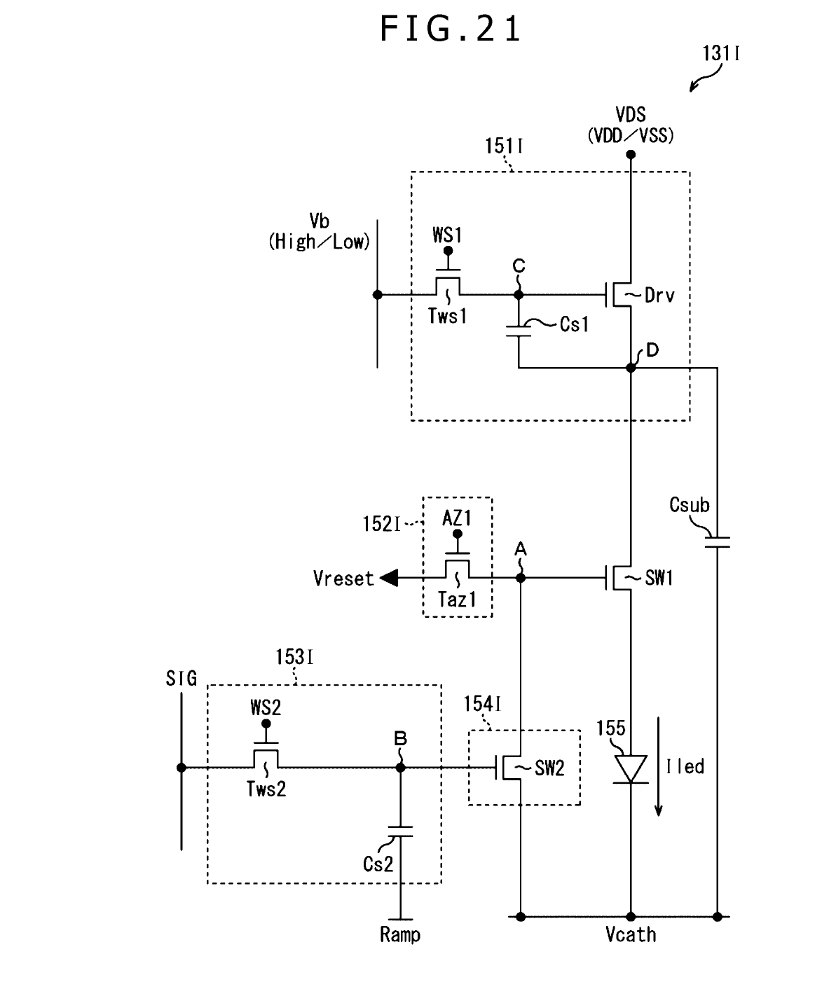

Referring to FIG. 21, there is shown an exemplary configuration of a pixel circuit 131I that is the fifth embodiment of the pixel circuit 131.

According to equation (1) mentioned above, drain current Ids(Drv) of the drive transistor Drv depends not only on threshold voltage Vth(Drv) but also on mobility μ(Drv).

On the other hand, mobility μ(Drv) of the drive transistor Drv varies for each device. This variation in mobility μ(Drv) causes the variation in current Iled that flows through the light-emitting device 155. As a result, the luminance characteristic varies between pixels, thereby causing degraded image quality.

By contrast, the pixel circuit 131I is configured to correct the variation in mobility μ(Drv) in addition to the variation in threshold voltage Vth(Drv) of the drive transistor Drv.

The pixel circuit 131I differs from the pixel circuit 131C shown in FIG. 9 that a constant current drive circuit 151I, an initialization circuit 152I, a signal input circuit 153I, and a switching circuit 154I instead of the constant current drive circuit 151C, the initialization circuit 152C, the signal input circuit 153C, and switching circuit 154C.

Of these components, the initialization circuit 152I, the signal input circuit 153I, and the switching circuit 154I have substantially the same configurations as those of the initialization circuit 152C, the signal input circuit 153C, and the switching circuit 154C of the pixel circuit 131C.

The constant current drive circuit 151I is configured to include an N-channel type drive transistor Drv, an N-channel type write transistor Tws1, and a capacitor Cs1.

The drain of the drive transistor Drv is connected to power supply VDS included in the power supply control block 115 to be applied with voltage VDD or voltage VSS. The gate of the drive transistor Drv is connected to point C and the source is connected to point D.

The drain of the write transistor Tws1 is connected to bias power supply included in the power supply control block 115 to be applied with bias voltage Vb(High) or Vb(Low). The gate of the write transistor Tws1 is applied with gate signal WS1 from the transistor control block 114. The source of the write transistor Tws1 is connected to point C.

The capacitor Cs1 is connected between point C and point D.

As described above, the pixel circuit 131I is configured to include six transistors and three capacitors.

### [Driving Method]

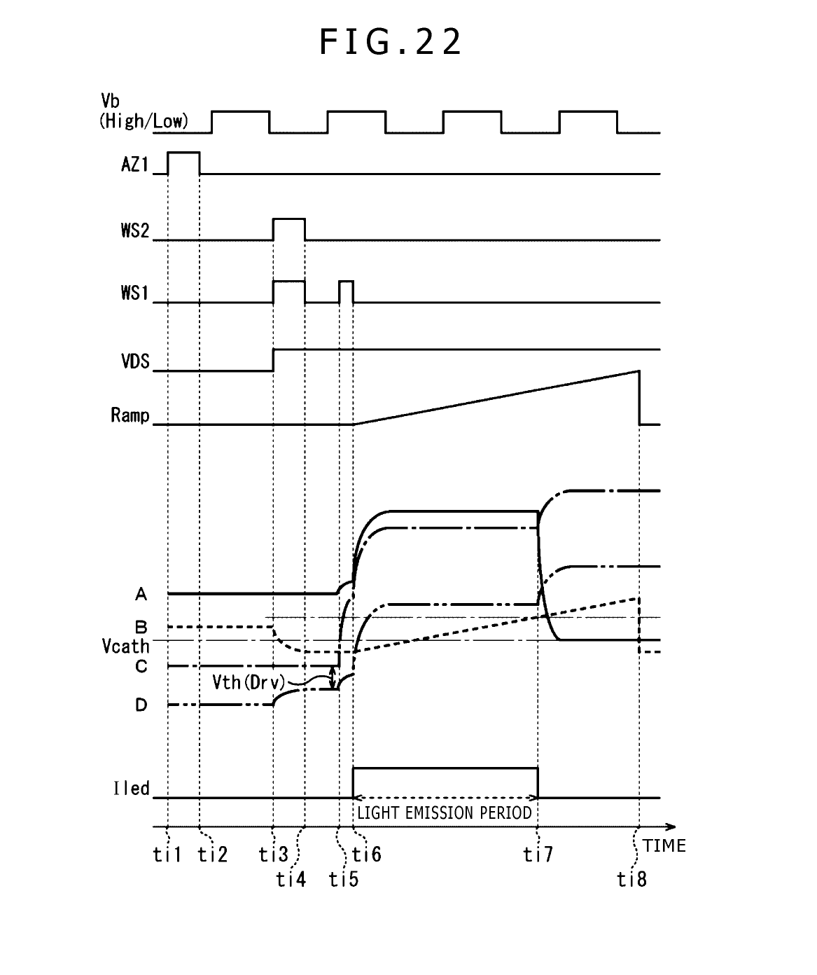

The following describes a method of driving the pixel circuit 131I with reference to the timing chart shown in FIG. 22.

It should be noted that the state of the pixel circuit 131I immediately before time ti1 is as follows.

The drive transistor Drv is on and the voltage of power supply VDS is set to voltage VSS. Therefore, the potential at point D is set to voltage VSS.

The write transistors Tws1 and Tws2, the initialization transistor Taz1, and the switching transistor SW2 are all off.

The switching transistor SW1 may be off or on. If the switching transistor SW1 is off, current Iled does not flow through the light-emitting device 155, so that the light-emitting device 155 is in the light-off state.

On the other hand, if the switching transistor SW1 is on, voltage VSS is set so as to satisfy equation (4) mentioned above, thereby preventing the light-emitting device 155 from emitting light.

At time ti1, gate signal AZ1 goes High, turning on the initialization transistor Taz1. Consequently, the potential at point A set to reset voltage Vreset.

It should be noted that, when the potential at point A is set to reset voltage Vreset, the switching transistor SW1 may be turned on or off. However, if the switching transistor SW1 is turned on, voltage VSS is set so as to satisfy equation (4) motioned above.

At time ti2, the gate signal AZ goes Low, turning off the initialization transistor Taz1.

At time ti3, gate signal WS1 goes High when the bias voltage is set to Vb(Low), thereby turning on the write transistor Tws1. Consequently, the potential at point C is set to bias voltage Vb(Low).

It should be noted that bias voltage Vb(Low) is set to a value with which the drive transistor Drv is not turned off.

At the same time, the voltage of power supply VDS is switched from voltage VSS to voltage VDD. Consequently, the potential at point D goes up with the potential at point C maintained at bias voltage Vb(Low). Then, when the potential at point D reaches Vb(Low)-Vth(Drv) and gate voltage Vgs(Drv) of the drive transistor Drv becomes equal to threshold voltage Vth(Drv), the drive transistor Drv is turned off.

It should be noted that, if the switching transistor SW1 is on at this point of time, then bias voltage Vb(Low) is set so as to satisfy equation (5) mentioned above, thereby preventing the light-emitting device 155 from emitting light.

Further, gate signal WS2 goes High, turning on the write transistor Tws2. At this moment, video signal SIG is set to signal voltage Vsig corresponding to the luminance of the pixel and the potential at point B is set to signal voltage Vsig.

At time ti4, gate signals WS1 and WS2 go Low, turning off the write transistors Tws1 and Tws2.

It should be noted that period of time enough for the potential at point D to reach Vb(Low)−Vth(Drv) is allocated in an interval between time ti3 and ti4.

At time ti5, gate signal WS1 goes High when bias voltage is set to Vb(High), thereby turning on the write transistor Tws1. Consequently, the potential at point C is set to bias voltage Vb(High). As a result, gate voltage Vgs(Drv) of the drive transistor Drv exceeds threshold voltage Vth(Drv), thereby turning on the drive transistor Drv.

Then, when predetermined time Δt has passed from time ti5, the potential at point D goes up to Vb(Low)−Vth(Drv)+ΔV. This voltage correction value ΔV depends on mobility μ(Drv) of the drive transistor Drv. Namely, as mobility μ(Drv) increases, voltage correction value ΔV increases; as mobility μ(Drv) lowers, voltage correction value ΔV lowers.

Then, gate voltage Vgs(Drv) of the drive transistor Drv becomes as expressed by equation (8) below.

Vgs(Drv)=Vb(High)−(Vb(Low)−Vth(Drv)+ΔV)=Vth(Drv)+(Vb(High)−Vb(Low)−ΔV). (8)

To be more specific, gate voltage Vgs(Drv) is set to a value obtained by adding predetermined bias voltage (Vb(High)−Vb(Low)) to threshold voltage Vth(Drv) and subtracting voltage correction value ΔV from the obtained value.

It should be noted that, at this time, the light-emitting device 155 maintains the light-off state by setting time Δt so as to satisfy relation (9) below.

Vb(Low)−Vth(Drv)+ΔV<Vth(led)+Vcath (9)

Then, at time ti6 when predetermined time Δt has passed from time ti5, gate signal WS1 goes Low. Consequently, the write transistor Tws1 is turned off and the gate (point C) of the drive transistor Drv gets in a float state.

On the other hand, because the drive transistor Drv is kept on and the drain of the drive transistor Drv is applied with voltage VDD, the potential at point D goes up to exceed Vth(led)+Vcath.

At the same time, because the gate (point C) of the drive transistor Drv is in the float state, the potential at point C goes up via the capacitor Cs1 in the same phenomenon as that of a so-called bootstrap circuit. As a result, the gate voltage Vgs(Drv) of the drive transistor Drv holds the value of equation (8) mentioned above.

Further, when the potential at point D goes up, the potential at point A goes up via the capacitor between the drain and gate of switching transistor SW1. Consequently, gate voltage Vgs(SW1) of the switching transistor SW1 exceeds threshold voltage Vth(SW1), turning on the switching transistor SW1 at least at this point of time.

Then, current Iled begins to flow through the light-emitting device 155 with the drive transistor Drv being the constant current source, upon which the light-emitting device 155 begins emitting light.

It should be noted that the value of drain current Ids(Drv) of the drive transistor Drv at this moment is expressed by equation (10) below by substituting gate voltage Vgs(Drv) of equation (8) into equation (1) mentioned above.

Ids(Drv)=k·μ(Drv)·(Vb(High)−Vb(Low)−ΔV)² (10)

As described above, setting gate voltage Vgs(Drv) to the value indicated by equation (8) allows drain current Ids(Drv) to be independent of threshold voltage Vth(Drv) of the drive transistor Drv as shown in the equation (10).

In addition, as described above, as mobility μ(Drv) increases, voltage correction value ΔV increases, so that drain current Ids(Drv) lowers accordingly. Inversely, as mobility μ(Drv) lowers, voltage correction value ΔV lowers, so that drain current Ids(Drv) increases accordingly. Therefore, the variation in mobility μ(Drv) is cancelled by voltage correction value ΔV, so that drain current Ids(Drv) becomes almost independent of mobility μ(Drv).

As a result, current Iled flowing through the light-emitting device 155 is not varied due to threshold voltage Vth(Drv) and mobility μ(Drv) of the drive transistor Drv to minimize the variation in the luminance characteristic of the pixels, thereby enhancing the image quality of the display apparatus 101.

Also, at this moment, the input of ramp signal Ramp into the capacitor Cs2 begins. As the voltage of ramp signal Ramp goes up, the potential at point B goes up via the capacitor Cs2 in a slope manner.

Then, at time ti7, when the potential at point B exceeds Vth(SW2)+Vcath, the switching transistor SW2 is turned on in the same manner as time ta6 shown in FIG. 6, thereby instantaneously turning off the switching transistor SW1. Consequently, the supply of current Iled to the light-emitting device 155 is instantaneously stopped, upon which the light-emitting device 155 moves from the light emission state to the light-off state.

### <13. Sixth Embodiment of the Pixel Circuit (Example of Correcting Drive Transistor Threshold Voltage and Mobility and Switching Transistor Threshold Voltage)>

### [Circuit Configuration]

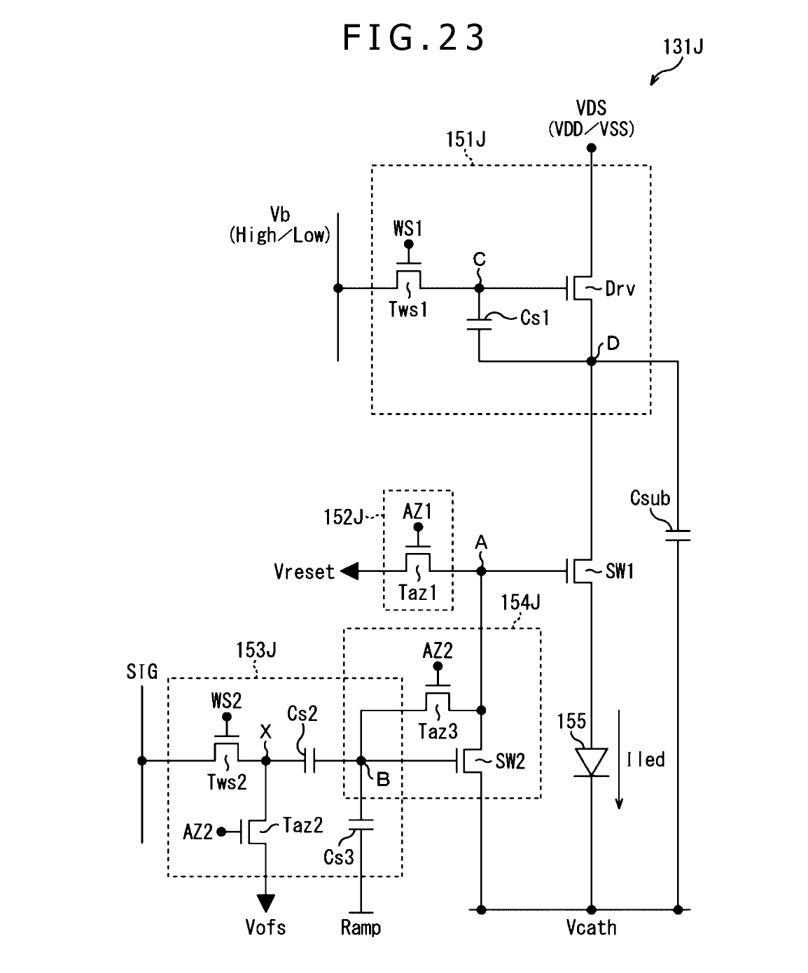

Referring to FIG. 23, there is shown an exemplary configuration of a pixel circuit 131J that is the sixth embodiment of the pixel circuit 131.

The pixel circuit 131J is configured to correct the variation in threshold voltage Vth(Drv) and mobility μ (Drv) of the drive transistor Drv and the variation in threshold voltage Vth(SW2) of the switching transistor SW2.

To be more specific, the pixel circuit 131J has a configuration in which the pixel circuit 131B shown in FIG. 7 and the pixel circuit 131I shown in FIG. 21 are combined together.

The pixel circuit 131J is configured to include a constant current drive circuit 151J, an initialization circuit 152J, a signal input circuit 153J, a switching circuit 154J, a light-emitting device 155, a switching transistor SW1, and a capacitor Csub.

Of these components, the constant current drive circuit 151J has substantially the same configuration as that of the constant current drive circuit 151I of the pixel circuit 131I shown in FIG. 21. The initialization circuit 152J, the signal input circuit 153J, and the switching circuit 154J have substantially the same configurations as those of the initialization circuit 152B, the signal input circuit 153B, and the switching circuit 154B of the pixel circuit 131B shown in FIG. 7.

It should be noted that some of the reference codes of the components of the signal input circuit 153J are changed from those of the signal input circuit 153B. To be more specific, the write transistor Tws is changed to the write transistor Tws2, gate signal WS is changed to gate signal WS2, and the capacitors Cs1 and Cs2 are changed to capacitors Cs2 and Cs3, respectively.

As described above, the pixel circuit 131J is configured to include eight transistors and four capacitors.

### [Driving Method]

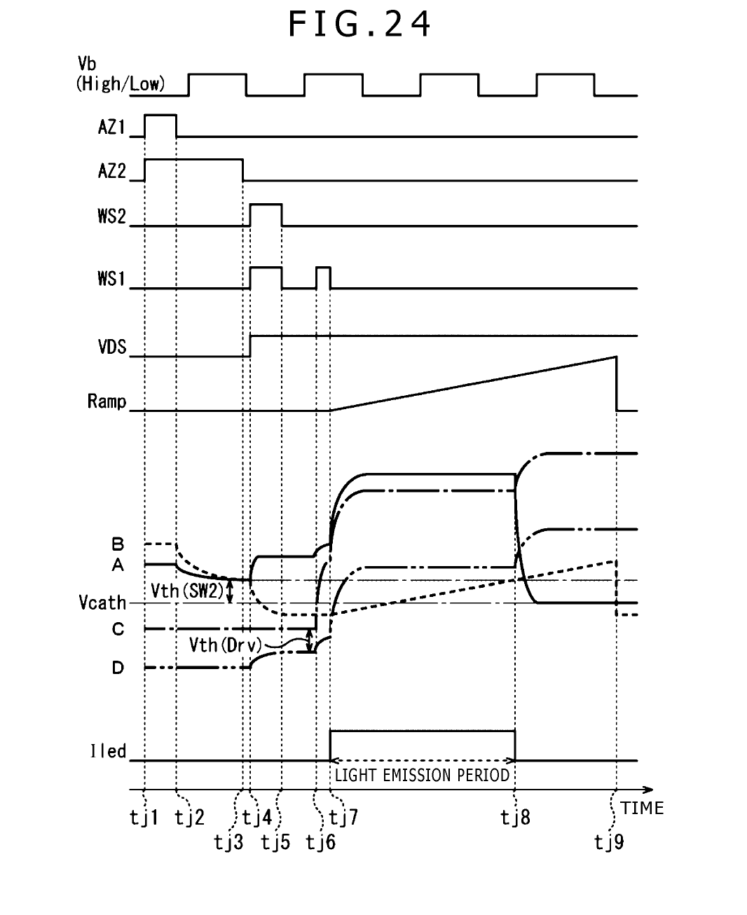

The following describes a method of driving the pixel circuit 131J with reference to the timing chart shown in FIG. 24.

It should be noted that the timing chart shown in FIG. 24 is basically a combination of the timing chart shown in FIG. 8 and the timing chart shown in FIG. 22.

To be more specific, in an interval between time tj1 and time tj3, substantially the same operations done by the initialization circuit 152B, the signal input circuit 153B, and the switching circuit 154B shown in FIG. 7 in the interval between time tb1 and time tb3 shown in FIG. 8 are executed by the initialization circuit 152J, the signal input circuit 153J, and the switching circuit 154J. Namely, the variation in threshold voltage Vth(SW2) of the switching transistor SW2 is corrected.

In an interval between time tj4 and time tj7, substantially the same operation done by the constant current drive circuit 151I shown in FIG. 21 in the interval between time ti3 and time ti6 shown in FIG. 22 is executed by the constant current drive circuit 151J. Namely, the variations in threshold voltage Vth(Drv) and mobility μ(Drv) of the drive transistor Drv are corrected.

Then, at time tj8, as with time ta6 shown in FIG. 6, when the potential at point B exceeds Vth(SW2)+Vcath, the switching transistor SW2 is turned on, upon which the switching transistor SW1 is instantaneously turned off. Consequently, the supply of current Iled to the light-emitting device 155 is instantaneously stopped, upon which the light-emitting device 155 moves from the light emission state to the light-off state.

<14. Examples of Products (Electronic Devices) to which the Technology Disclosed Herein is Applied>

The display apparatus 101 to which the technology disclosed herein may be installed on a variety of electronic devices.

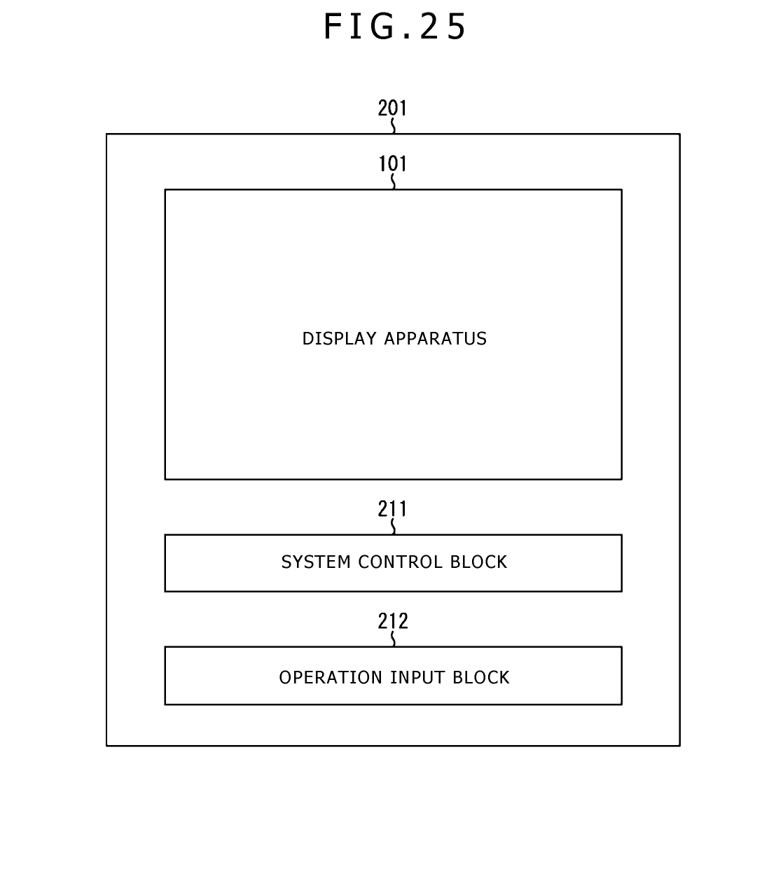

Referring to FIG. 25, there is shown an exemplary conceptual configuration of an electronic device 201. The electronic device 201 is configured by the display apparatus 101, a system control block 211, and an operation input block 212 that have been described above. The processing to be executed by the system control block 211 differs from model to model of the electronic device 201. The operation input block 212 is a device to receive operation input signals entered by the user to control the system control block 211. The operation input block 212 has a mechanical interface based on switches and buttons for example and a graphics interface, for example.

It should be noted that, if the electronic device 201 has a function of displaying images or video signals generated inside the device or supplied from the outside, the electronic device 201 is not restricted to those of a particular field.

Referring to FIG. 26, there is shown an external view of the electronic device 201 that is a television receiver for example.

On the front side of the housing of a television receiver 211, a display screen 233 is arranged that is configured by a front panel 231 and a filter glass 232, for example. The display screen 233 corresponds to the display apparatus 101.

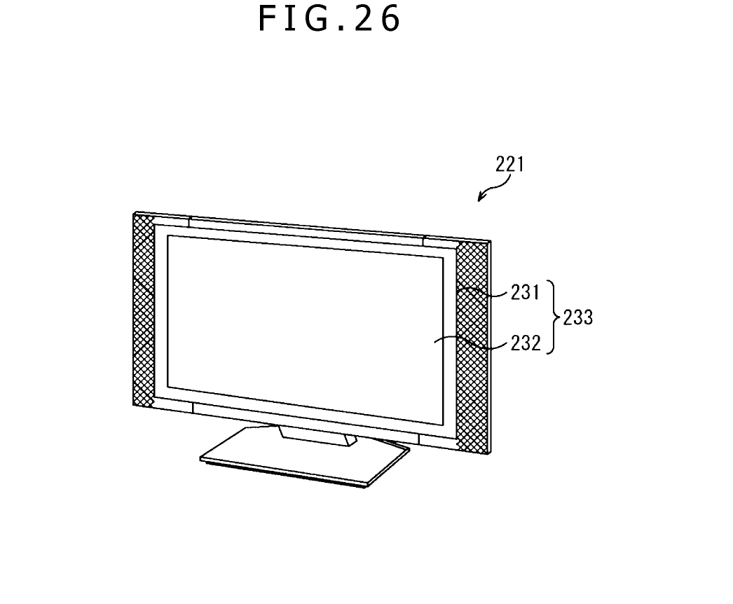

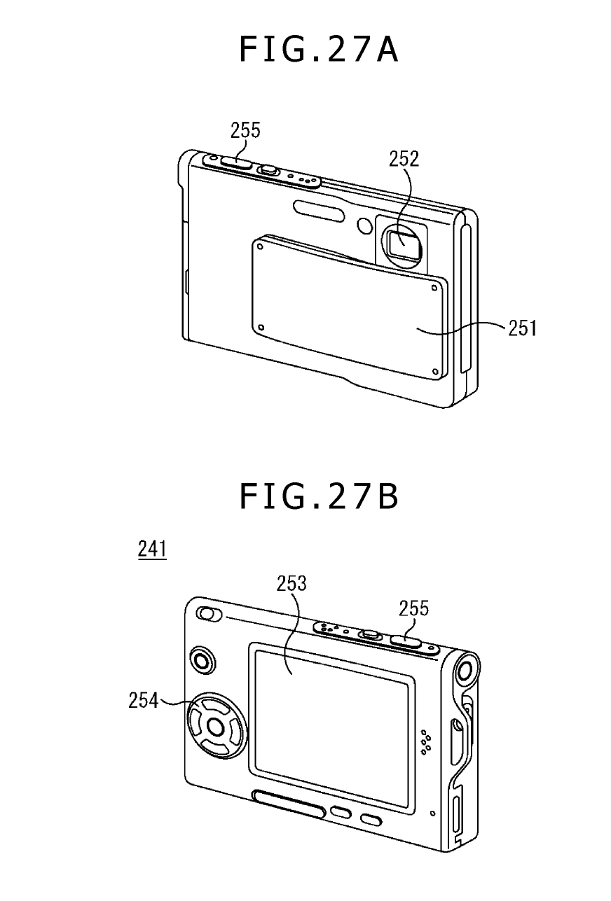

Further, the electronic device 201 of this type may be a digital camera for example. Referring to FIGS. 27A and 27B, there is shown perspective views of a digital camera 241. FIG. 27A shows the front view (the side of subject) while FIG. 27B shows the rear view (the side of photographer).

The digital camera 241 is configured by a protection cover 251, an imaging lens block 252, a display screen 253, a control switch 254, and a shutter button 255, for example. Of these components, the display screen 253 corresponds to the display apparatus 101.

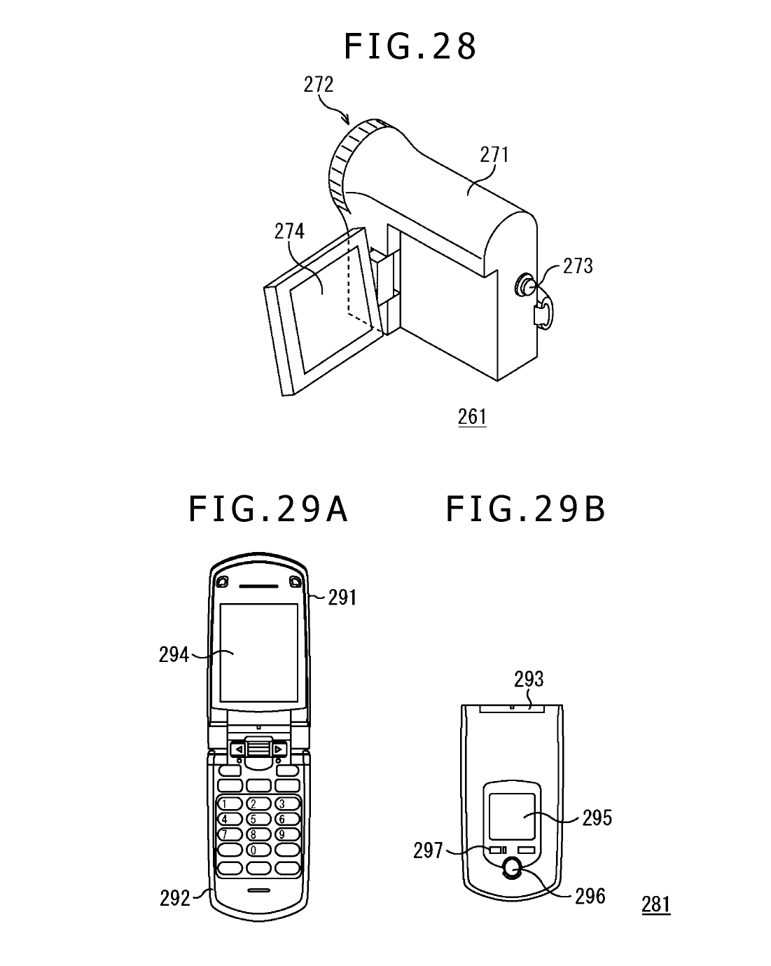

In addition, for the electronic device 201 of this type, a video camera for example is assumed. FIG. 28 shows an exemplary external view of a video camera 261.

The video camera 261 is configured by a main body 271, an imaging lens block 272 for imaging a subject arranged in front of the main body 271, an imaging start/stop switch 273, and a display screen 274, for example. Of these components, the display screen 274 corresponds to the display apparatus 101.

Moreover, for the electronic device 201 of this type, a portable terminal apparatus for example is assumed. FIGS. 29A and 29B show exemplary external views of a mobile telephone 281 that is a portable terminal apparatus. The mobile telephone 281 shown in FIG. 29 is of a folding type. FIG. 29A shows an exemplary external view of the mobile telephone 281 with the housing thereof unfolded. FIG. 29B shows an exemplary external view of the mobile telephone 281 with the housing thereof folded.

The mobile telephone 281 is configured by an upper housing monitor apparatus 291, a lower housing 292, a linking block (a hinge block in this example) 293, a display screen 294, a sub display screen 295, a picture light 296, and an imaging lens 297, for example. Of these components, the display screen 294 and the sub display screen 295 correspond to the display apparatus 101.

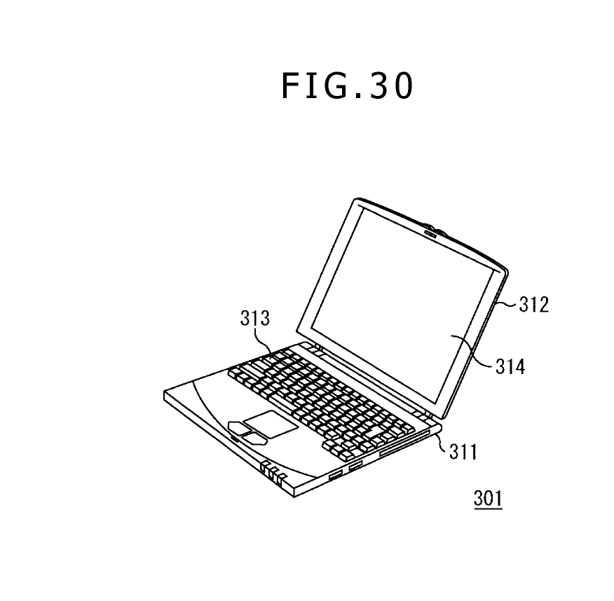

Also, for this electronic device 201 of this type, a computer for example is assumed. FIG. 30 shows an exemplary external view of a note-type computer 301.

The note-type computer 301 is configured by a lower housing 311, an upper housing 312, a keyboard 313, and a display screen 314, for example. Of these components, the display screen 314 corresponds to the display apparatus 101.

In addition, the electronic device 201 may be an audio reproduction apparatus, a game machine, an electronic book, an electronic dictionary, and so on, for example.

### <15. Variations>

The following describes variations to the embodiments of the technology disclosed herein.

The structures (P-channel type and N-channel type) of the transistors making up the pixel circuit 131 are not restricted to those mentioned above; these structures may be replaced as required. If these structures of the transistor are replaced, changes are added such that the polarities of a power supply (a bias voltage or the like) and a control signal (a gate signal or the like) are changed and the waveform of a ramp signal Ramp is decreased in a slope manner as required, for example.

In the above description, the potential of the source of the switching transistor SW2 and the potential of the cathode of the light-emitting device 155 are set to the same voltage Vcath; however, these potentials need not always be set to the same level.

Further, while preferred embodiments of the present technology have been described using specific terms, such description is for illustrative purpose only, and it is to be understood that changes and variations may be made without departing from the spirit or scope of the following claims.

For example, the technology disclosed herein may take the following configuration.

(1) A pixel circuit including:

a light-emitting device;

a constant current drive circuit configured to include
a first transistor as a constant current source for supplying a predetermined current to the light-emitting device;

a second transistor configured to open/close electrical connection between the first transistor and the light-emitting device; and

a switching circuit configured to switch between an on state and an off state of the second transistor by controlling a gate voltage of the second transistor.

(2) The pixel circuit according to (1) above, wherein the switching circuit includes a third transistor for opening/closing electrical connection between a gate of the second transistor and a predetermined potential and connects the gate of the second transistor to the potential via the third transistor, thereby turning off the second transistor.

(3) The pixel circuit according to (2) above, further including:

a signal input circuit configured to enter a ramp signal that increases or decreases from an initial voltage corresponding to a luminance of a pixel in predetermined slope into the gate of the third transistor.

(4) The pixel circuit according to (3) above, wherein the signal input circuit sets the initial voltage with reference to a threshold voltage of the third transistor.

(5) The pixel circuit according to (4) above, wherein the signal input circuit sets the initial voltage by applying a voltage corresponding to the luminance of the pixel to the gate of the third transistor via a capacitor with the gate voltage of the third transistor set to a threshold voltage.

(6) The pixel circuit according to any one of (1) through (5) above, wherein the constant current drive circuit sets a gate voltage of the first transistor to a first value obtained by adding a predetermined bias voltage to a threshold voltage of the first transistor, thereby supplying a current to the light-emitting device.

(7) The pixel circuit according to (6), wherein the constant current drive circuit sets the gate voltage of the first transistor to a second value obtained by further subtracting a voltage corresponding to a mobility of the first transistor from the first value and supplies a current to the light-emitting device.

(8) A pixel circuit driving method including:

supplying a predetermined current to a light-emitting device from a constant current drive circuit including a first transistor as a constant current source, thereby causing the light-emitting device to emit light; and

controlling a gate voltage of a second transistor for opening/closing electrical connection between the first transistor and the light-emitting device to turn off the second transistor, thereby stopping light emission of the light-emitting device.

(9) A display apparatus including:

a pixel array in which pixel circuits are arranged in a matrix, each of the pixel circuits including
a light-emitting device,
a constant current drive circuit configured to include a first transistor as a constant current source for supplying a predetermined current to the light-emitting device,
a second transistor configured to open/close electrical connection between the first transistor and the light-emitting device, and
a switching circuit configured to switch between an on state and an off state of the second transistor by controlling a gate voltage of the second transistor; and

a drive control block configured to control driving of the pixel circuits.

(10) An electronic device including:

a pixel array in which pixel circuits are arranged in a matrix, each of the pixel circuits including
a light-emitting device,
a constant current drive circuit configured to include a first transistor as a constant current source for supplying a predetermined current to the light-emitting device,
a second transistor configured to open/close electrical connection between the first transistor and the light-emitting device, and
a switching circuit configured to switch between an on state and an off state of the second transistor by controlling a gate voltage of the second transistor; and

a drive control block configured to control driving of the pixel circuits.

The present application contains subject matter related to that disclosed in Japanese Priority Patent Application JP 2011-216114 filed in the Japan Patent Office on Sep. 30, 2011, the entire content of which is hereby incorporated by reference.

What is claimed is:

1. A pixel circuit comprising:
a light-emitting device;
a constant current drive circuit configured to include
a first transistor as a constant current source for supplying a predetermined current to said light-emitting device;
a second transistor configured to open/close electrical connection between said first transistor and said light-emitting device; and
a switching circuit configured to switch between an on state and an off state of said second transistor by controlling a gate voltage of said second transistor.

2. The pixel circuit according to claim 1, wherein said switching circuit includes a third transistor for opening/closing electrical connection between a gate of said second transistor and a predetermined potential and connects the gate of said second transistor to said potential via said third transistor, thereby turning off said second transistor.

3. The pixel circuit according to claim 2, further comprising:
a signal input circuit configured to enter a ramp signal that increases or decreases from an initial voltage corresponding to a luminance of a pixel in predetermined slope into the gate of said third transistor.

4. The pixel circuit according to claim 3, wherein said signal input circuit sets said initial voltage with reference to a threshold voltage of said third transistor.

5. The pixel circuit according to claim 4, wherein said signal input circuit sets said initial voltage by applying a voltage corresponding to the luminance of said pixel to the gate of said third transistor via a capacitor with the gate voltage of said third transistor set to a threshold voltage.

6. The pixel circuit according to claim 1, wherein said constant current drive circuit sets a gate voltage of said first transistor to a first value obtained by adding a predetermined bias voltage to a threshold voltage of said first transistor, thereby supplying a current to said light-emitting device.

7. The pixel circuit according to claim 6, wherein said constant current drive circuit sets the gate voltage of said first transistor to a second value obtained by further subtracting a voltage corresponding to a mobility of said first transistor from said first value and supplies a current to said light-emitting device.

8. A pixel circuit driving method comprising:
supplying a predetermined current to a light-emitting device from a constant current drive circuit including a first transistor as a constant current source, thereby causing said light-emitting device to emit light; and
controlling a gate voltage of a second transistor for opening/closing electrical connection between said first transistor and said light-emitting device to turn off said second transistor, thereby stopping light emission of said light-emitting device.

9. A display apparatus comprising:
a pixel array in which pixel circuits are arranged in a matrix, each of said pixel circuits including
a light-emitting device,
a constant current drive circuit configured to include a first transistor as a constant current source for supplying a predetermined current to said light-emitting device,
a second transistor configured to open/close electrical connection between said first transistor and said light-emitting device, and
a switching circuit configured to switch between an on state and an off state of said second transistor by controlling a gate voltage of said second transistor; and
a drive control block configured to control driving of said pixel circuits.

10. An electronic device comprising:
a pixel array in which pixel circuits are arranged in a matrix, each of said pixel circuits including
a light-emitting device,
a constant current drive circuit configured to include a first transistor as a constant current source for supplying a predetermined current to said light-emitting device,
a second transistor configured to open/close electrical connection between said first transistor and said light-emitting device, and
a switching circuit configured to switch between an on state and an off state of said second transistor by controlling a gate voltage of said second transistor; and
a drive control block configured to control driving of said pixel circuits.
